(19) United States
(12) Patent Application Publication
(10) Pub. No.: US 2003/0023467 A1
(43) Pub. Date: Jan. 30, 2003

(54) Method for developing and promoting operations and services that are supported by an energy, energy efficiency, water management, environmental protection and pollution prevention fund

(76) Inventor: Vlad Moldovan, Brookfield, WI (US)

Correspondence Address: JOSEPH S. HEINO, ESQ., DAVIS & KUELTHAU, S.C., 111 E. KILBOURN, SUITE 1400, MILWAUKEE, WI, 53202-6613, US

(21) Appl. No.: 09/918,069

(22) Filed: Jul. 30, 2001

(51) Int. Cl. G06F 17/60

(52) U.S. Cl. 705/7

(57) ABSTRACT

A method is provided for developing and promoting certain operations and services under a specialized collection of programs that are financially supported by a fund that is established for energy efficiency, water management, environmental protection and pollution prevention purposes. The method utilizes qualified experts to implement and supervise various projects in different sectors and employs certain incentives as inducement to participation in the method.

### FIELD OF THE INVENTION

The present invention relates to methods for developing and promoting energy conservation. More particularly, it relates to a method for developing and promoting certain operations and services under a specialized collection of programs that are financially supported by a fund that is established for energy efficiency, water management, environmental protection and pollution prevention purposes.

### BACKGROUND OF THE INVENTION

In the experience of this inventor, energy conservation is a top priority for governments, businesses and individuals alike. Governmental and private sector programs which emphasize and encourage energy efficiency, water management, environmental protection and pollution prevention can create long term, well-paying jobs for many people having a wide range of qualifications and experiences. If implemented these programs can increase the market share, the profitability and the educational level of businesses and individuals associated with them.

### SUMMARY OF THE INVENTION

Accordingly, it is an object of the present invention to provide a method for developing and promoting certain operations and services under a specialized collection of programs that are financially supported by a fund that is established for energy efficiency, water management, environmental protection and pollution prevention purposes. The method utilizes qualified experts to implement and supervise the programs. Incentives are provided for participation in the program(s). If implemented the world shall be much safer and better off.

### DESCRIPTION OF DRAWINGS

FIGS. 1 and 2 are schematic block diagrams illustrating the sources of money for the creation of the fund that is the subject of the method of the present invention.

FIGS. 3A, 3B, 3C and 3D are interrelated schematic block diagrams illustrating the existing buildings sector program and financing mechanism, which diagrams apply to other sector programs of the method as well.

FIG. 4 is a schematic block diagram illustrating the additional steps that are required with the new commercial buildings sector program.

FIG. 5 is a schematic block diagram illustrating the schools sector program that is part of the method of the present invention.

FIG. 6 is a schematic block diagram illustrating the agricultural markets sector program that is part of the method of the present invention.

### DETAILED DESCRIPTION

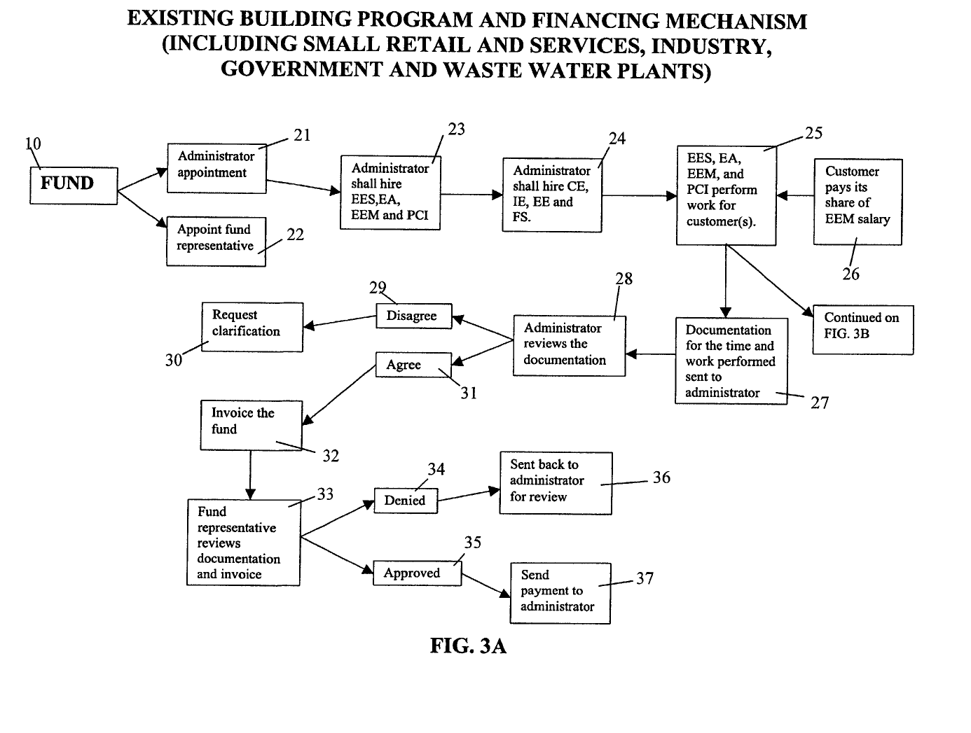

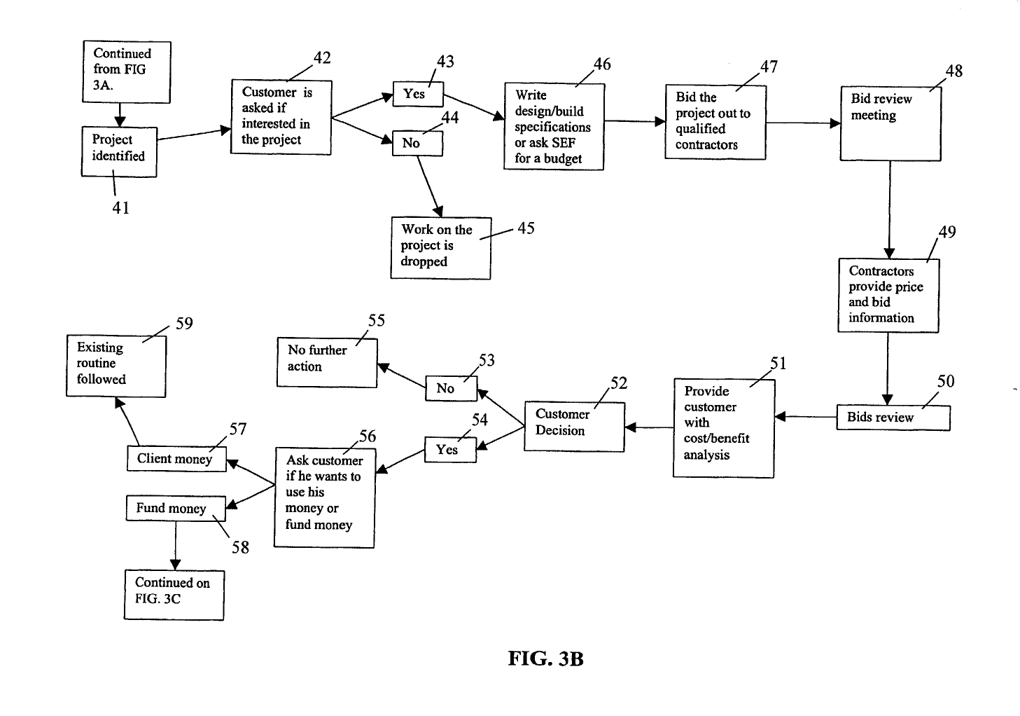

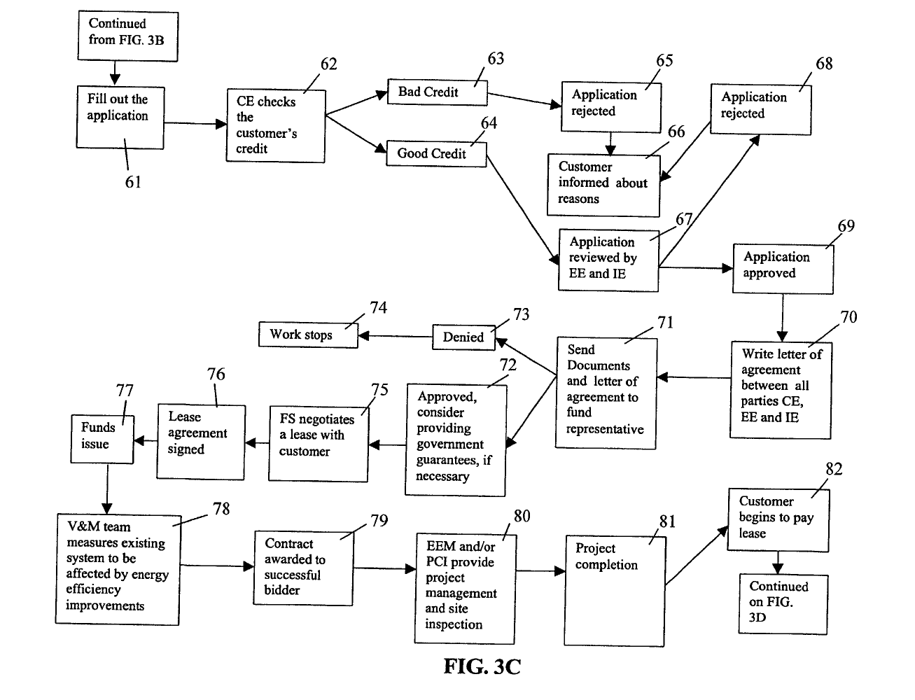

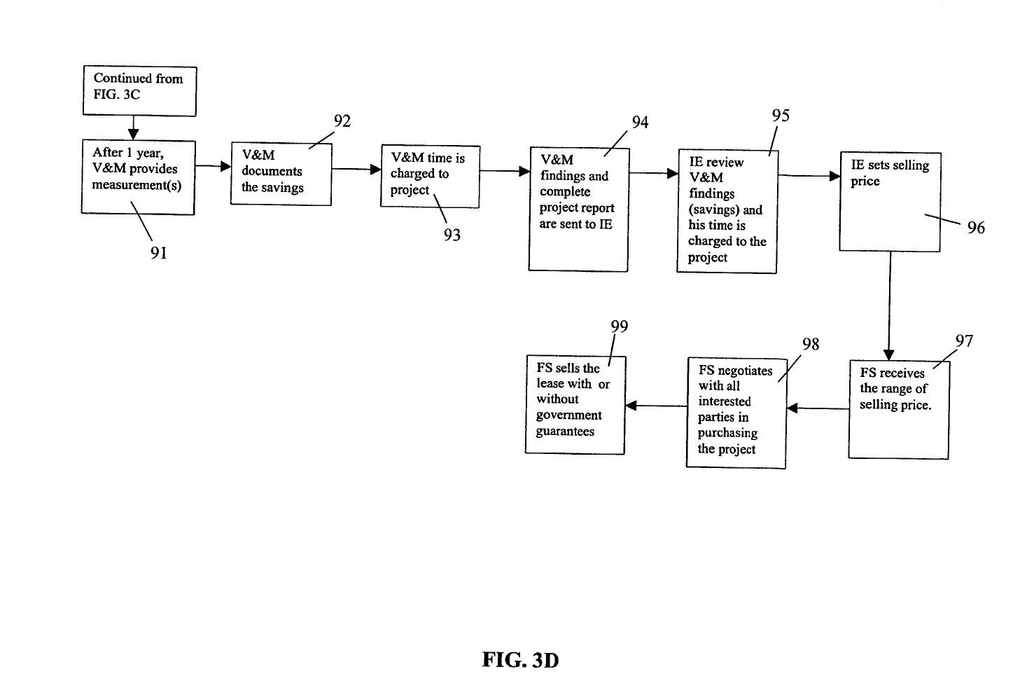

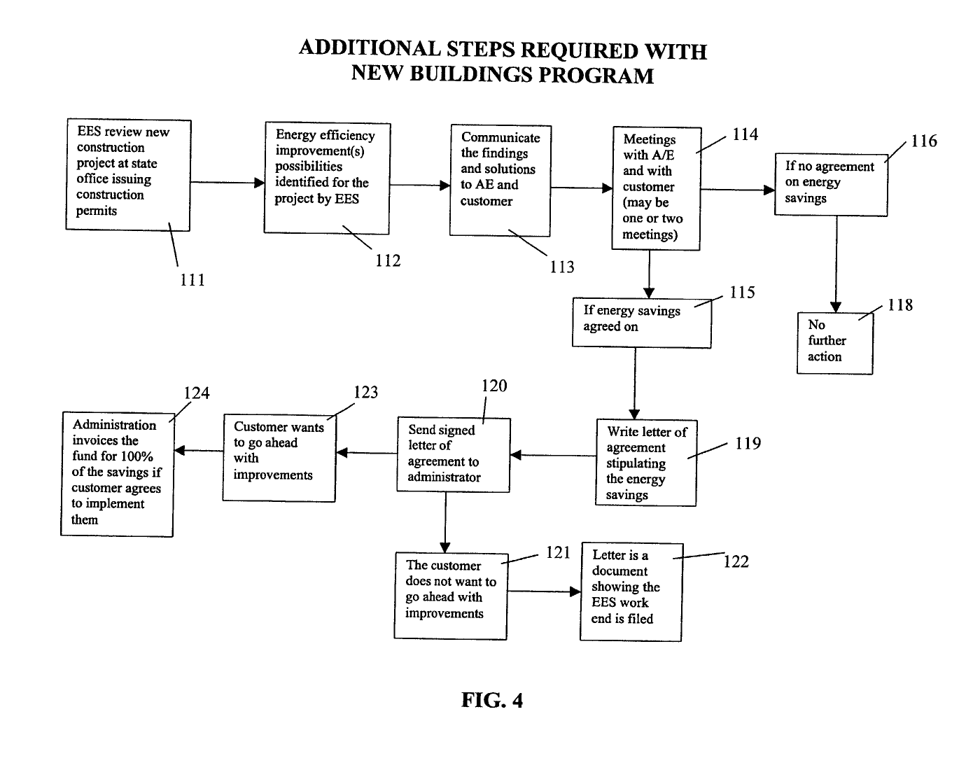

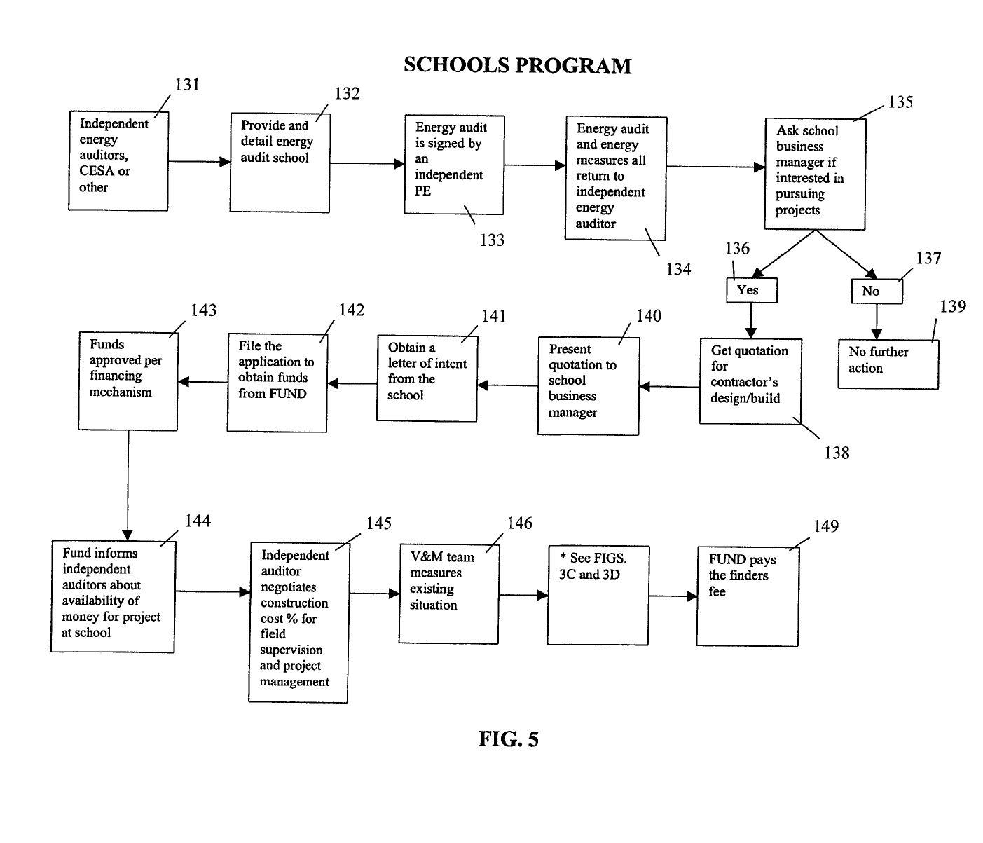

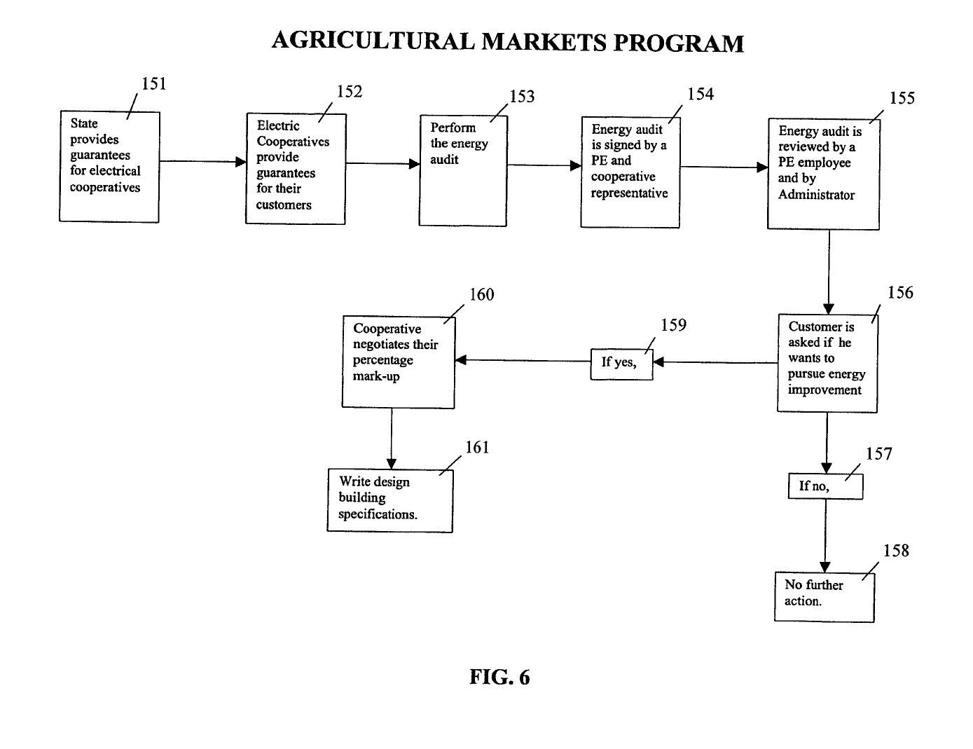

The method of the present invention establishes a number of programs, each of which is crucial to the success of the method. One such program deals with newly constructed commercial buildings. See FIG. 4. Another deals with existing buildings. See FIGS. 3A, 3B, 3C and 3D. Still others deal with industrial applications, agricultural markets, schools, governmental buildings and water and wastewater treatment plants. See FIGS. 5 and 6. Each of those, and a few others, will be discussed as part of the overall system of programs in the method of the invention.

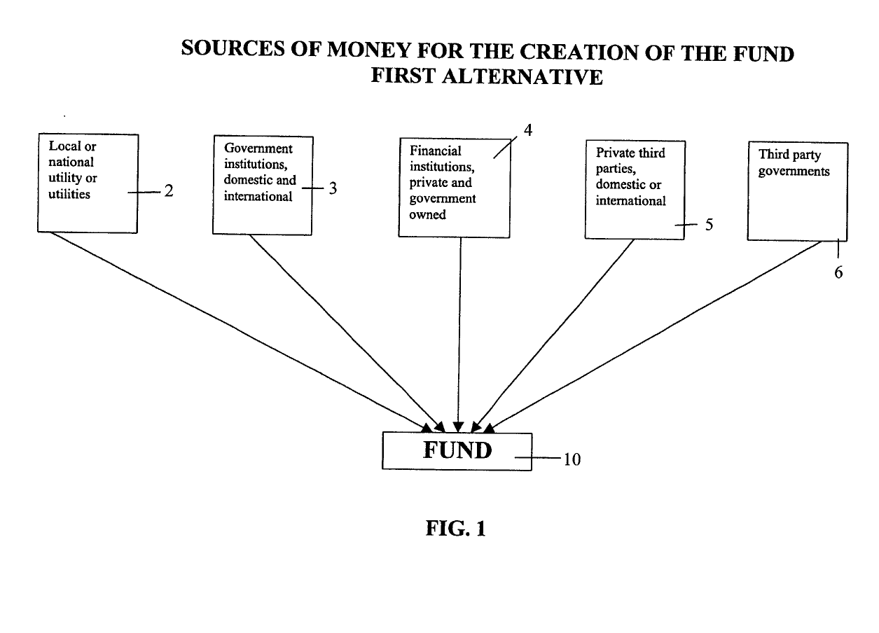

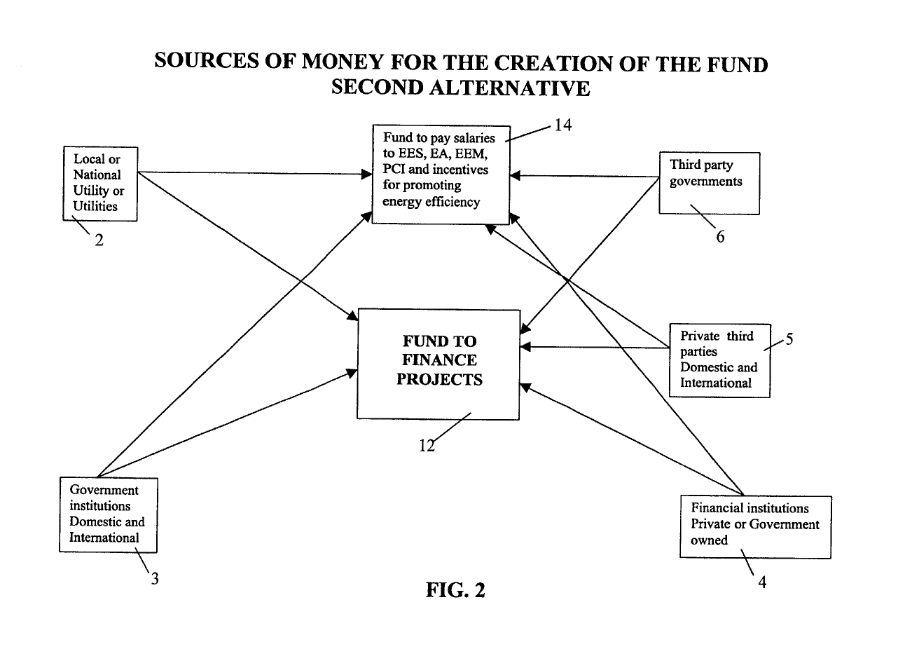

The State of Wisconsin shall provide a large amount of money to facilitate the creation of the “Energy, Energy Efficiency, Water Management, Environmental Protection and Pollution Prevention Fund” (“The Fund” or “Fund” 10). See FIGS. 1 and 2. All energy auditors (EA's), energy engineers/managers (EEM's), energy efficiency specialists (EES 's), and pollution control inspectors (PCI's) shall be paid 14 by the Administrator 21 from the “Fund” 10 or other sources (government and/or private) 2, 3, 4, 5, 6. Specifically, provenience of money for creation of the Fund 10 shall be from (a) Local/national utilities 2 and be use by the Fund instead being spent on rebates or other DSM incentives without a chance to make a profit and create a business; (b) Private and/or government owned financial institutions, domestic or international 4; (c) US and/or foreign government organizations 3; (d) third party governments 6; (e) third party private organizations 5. The money can be use to create one Fund 10 that will finance the projects and pay the incentives and salaries, or part of it, of all people involved and as described in this business model. It is also possible that the Fund 10 finances the projects and others pay these salaries and incentives.

New Buildings Sector Program

In each location where construction permits are issued and plans are reviewed for code compliance, an energy efficiency specialist (or “EES”) would evaluate 111, 112 each new construction project from the energy efficiency side. See FIG. 4. The EES can be employed by, or be a sub-contractor of a “Major Markets Administrator,” or individual who administers the major markets consisting of industrial, medical, commercial, institutional, schools, farms, government buildings. The EES must have a degree of BSME or BSEE, must be a registered professional engineer and the holder of a valid PE license. The EES must be fully experienced in the design and operation of building mechanical and/or electrical systems, including HVAC/R, plumbing, compressed air, lighting, controls, and power distribution. The EES shall identify 112, if possible, ways and provide ideas that save energy in excess of governmental codes. In this inventor's home state, for example, this would be in excess of the requirements of the Wisconsin Commercial Building Energy Code. The ways and ideas shall include, but are not limited to, different design, using more efficient equipment than that specified, different and/or better sequence of operation for controls, off-peak schedule for equipment operation and safety measures. They shall also prevent the waste of energy, in case of controls and/or equipment malfunction, recommend the most economical fuel and fuel changes, if necessary and possible, and promote load shaving. And all of this must be done without changing and/or affecting in any way the owner's comfort requirement(s). The energy savings shall be documented and brought to the owner(s) attention. The EES must base his or her work on, and incorporate, equipment that meets Energy Star, FEMP Guidelines, and Consortium for Energy Efficiency (CCE) and/or ASHRAE standards.

The owner shall arrange a meeting 114 between the designer(s) of the mechanical and electrical systems, the architect and the EES. At this meeting, the EES shall provide 113, 114 all documentation upon which he or she calculated the energy savings, including all assumptions, calculations, equipment specifications, approved operation schedules, etc.

After the technical discussion with the architect and engineer, and if all parties agree, the agreed energy savings 115, 116, 118 shall become official for that project. The official document 119 shall stipulate the amount of annual energy savings, calculation method(s), and all the, information and/or documentation agreed on by the parties. Also, the document shall specifically identify the location of the project, the project owner, the engineer, the architect and the EES and shall be signed by each of them 120, 121, 122, 123. All of the above shall be done without reducing and, if possible, by improving the comfort level of the occupant(s). The governmental body shall pay the Major Markets Administrator one hundred percent (100%) of the officially agreed upon annual energy savings 124 as an incentive for promoting energy efficiency within the governmental territory. It is to be understood that this governmental territory could be any state, part of a state, part of the United States, any province or part of any foreign county or just the foreign country itself without departing from the scope of the method of the present invention.

The above program shall:

1. Increase the number of building owners who seek and value information regarding more comfortable, energy efficient, new buildings.

2. Offer education and training programs to assist building operators in maintaining and/or building efficiency.

3. Increase the number of new architects and engineers involved in designing commercial buildings that are built significantly more efficient and safer than present code(s) requirements.

Existing Buildings Sector Program

One major way to achieve energy savings and/or increase energy efficiency is to have in place a Preventive Maintenance Program (PM). This can be done by the Owner's own people, or be contracted out to a Mechanical Contractor 25. See FIG. 3A. Why a mechanical contractor? Most of the building energy users are part of the mechanical systems: HVAC/R, plumbing and compressed air. The equipment requiring PM can be, but is not limited to: air compressors, boilers, chillers, rooftop AC units, cooling towers, domestic hot water heaters, pumps, blowers, air handler units, controls etc. To provide PM to the above-mentioned equipment requires a highly specialized person. The PM required by lighting system can be done with less qualified people because it involves only the cleaning and/or replacing of the lamps. Part of the mechanical PM program is to have a full inventory of the equipment. Routine work includes, but is not limited to: changing and/or cleaning of the air/water filters, coils and burners, checking the refrigerant level for AC units, combustion tests and/or water treatment for boilers and cooling towers etc. The amount of time and/or type of work mentioned-above shall be done in accordance with the signed agreement by all interested parties: the PM Contractor and the Owner and/or Operator. The agreements (or contracts) can be for one or multiple year(s), two or three, before it is bid again. If the contract is for multiple years, the building Owner and/or Operator shall require the contracting party (supplier of the PM contract) to provide him and/or them with an Energy Audit. Only the qualified personnel shall perform the required light Energy Audit. The energy audit shall include, but shall not be limited to, type and description of: building occupancy, area(s) audited (SF), energy consumption evaluation for the last 2-3 years, energy conservation measures, describing existing situation/operation, and proposed improvements in operation and/or projects, calculation of the energy savings, project(s) estimation and financial justification. Also, the energy audit must include an energy management plan and a multi-year budget for energy and energy efficiency improvements and priorities. The performer, energy auditor (EA), shall have strong experience in the energy efficiency field, HVAC/R, plumbing and lighting design, BSME/BSEE, holder of a valid PE license and/or have other recognized and approved certification. Each multi-year PM contract shall include an energy audit. The Energy Audit shall benefit both parties: the Owner and/or Operator and PM Contractor. The Owner(s) and/or Operator(s) will benefit because it will be brought to their attention ways to save energy and money and how to lower the operation costs of, or in, their buildings. The PM Contractor can benefit because he will identify the new projects and has the most chances to implement them. Other third parties can benefit, also if the energy auditor will identify non-mechanical projects: more efficient lighting, better and/more insulation for roofs and walls, energy efficient windows and/or doors, etc.

Also the Owner and/or Operator shall require, in their agreement with the PM contractor, that the new equipment coming into the building, for new projects and/or replacing existing ones, must meet the “Energy Star” standards. Above all, proposed and/or implemented recommendation(s) shall be done without reducing and, if possible, improving the occupant(s) comfort level. Before being presented to Owner(s) and/or Operator(s), the energy audit report shall be reviewed and approved by the PM Contractor. When handed to the Owner and/or Operator, the report shall bear the signatures of the EA and PM Contractor, authorized personnel. Other benefits for the Owner and/or Operator shall be lower rates on Demand Maintenance and priority on services when equipment malfunction(s) will occur.

To prevent pollution and be environmentally compliant at all locations included in this PM contract, the PM contractor shall hire a specialist to perform an environmental audit, or contract out to somebody else, this side of the business. The pollution control inspector (PCI) shall be a graduate engineer, BSME/BSCE, with 2-3 years experience in environmental engineering, pollution control and environmental compliance area(s). This person shall inspect every 3 years the existing commercial building(s) assigned to him. The inspection schedule may be more frequent if necessary. If this person will encounter a situation requiring more expertise, the proper advice can come from the specialized personnel of a specialized engineering firm (SEF). SEF shall provide advice in addition to energy efficiency and environmental engineering services (design and/or design/built) in all the area(s) mentioned above.

For larger buildings, the EA(s) can be replaced with an energy engineer/manager (EEM). The “Administrator” shall provide 23 on site EEM's to all companies who can't have their own. The amount of labor supplied by the EEM's shall be in accordance and/or agreement with the plant(s) management request(s) (8-12 hrs/week or more if needed at each location). The EEM's shall: evaluate the energy usage for the last 3 years, provide the plant with an energy audit, obtain financing and management approval for the identified projects, negotiate energy rates an tariffs, purchase energy, design an energy management plan with a multi-year budget for energy and energy efficiency improvements 25. Also, the EEM's shall set up annual goals for reducing energy consumption. If the projects are approved and money is available, the EEM shall write the design/build specifications for contractors and/or the scope of work for consulting engineers. All EEM's must solicit, evaluate and review bids from design/build contractors 48, 49, 50. See FIG. 3B. Also part of the job is to recommend to the plant management the successful bidder based on quality, ability to perform the job and price. If it is a major project and/or requires the services of a specialized engineering firm (SEF), the EEM(s) shall hire, with the plant(s) management approval, one of the contractors identified in this proposal, SEF on time and materials, not to exceed, basis. During the engineering process, the EEM shall have meetings with all parties involved and make sure that the outcome will be in accordance with his ideas and concepts. Also, the equipment specified, shall meet the “Energy Star” standards. After the design is complete, the EEM must supervise the implementation by providing field supervision, construction and project management services. All invoices submitted by contractors shall bear the signature and approval of the EEM and plant designated representative. Only after that, the contractor can receive payment for his work.

If the customer intends to expand and build a new addition to the existing facilities, the EEM shall identify all requirements from the mechanical and electrical point of view and provide the information to the plant management. If required, with the assistance of specialized personnel identified in the present proposal, the EEM can provide an approximate cost estimate for budget purpose. Above all, the EEM's shall be the company liaison with between utilities (electric, gas and water), AE firms, specialized energy efficiency/environmental engineering firm and contractors.

The EEM must be a qualified person, fully experienced in the design of HVAC/R, compressed air, plumbing, piping, pumping and lighting/electrical systems with strong exposure to energy efficiency, holder of a valid PE license and a BSME/BSEE. In addition to that a CEM certification will be beneficial. The number of EEM's can be decided, based on demand.

To prevent pollution and be environmentally compliant at all locations included in this program, the PM contractor shall hired from, through or contract out to somebody else, this side of the business. The pollution control inspector (PCI) shall be a graduate engineer, BSME/BSCE, with 2-3 years experience in environmental engineering, pollution control and environmental compliance area(s). This person shall inspect every 3 years the existing commercial building(s) assigned to him. This inspection frequency may be increased if necessary. If this person will encounter a situation requiring more expertise, the proper advice can come from the specialized personnel of SEF. SEF shall provide advice in addition to energy efficiency and environmental engineering services (design and/or design/built) in all the area(s) mentioned above.

To reinforce all of the above, the State shall require from all contractors selling PM contracts, to provide an energy and environmental audit, disclose every year how many energy and environmental audits were perform by them, or on their behalf, and provide the proof, the report(s) 27, 28, 29, 30, 31, 33, 34, 35, 36, 37. See FIG. 3A. If desired by the PM contractor(s), the EA(s), EEM(s) and PCI(s) can be provided by the Administrator 23. The cost must be supported by the State. A light energy audit shall not take more than 40 hours and the environmental one no more than 24 hours.

It shall be specially noted that the EA/EEM shall determine, every year, the energy consumption: natural gas, oil and electricity, per square foot of each building assigned to him/her. The energy consumption of the building must be compared every year with the previous year. Changes in energy consumption shall be quantified in percentages. The changes in percentages for thermal energy and electricity consumption per square foot can be combined to come out with the average. This percentage, hopefully, will go down due to the energy efficiency improvements. As an incentive to promote energy efficiency, the STATE and/or the local government having jurisdiction shall reduce the property taxes accordingly. Every year the local power and/or the natural gas distribution company shall record the amount of degree heating/cooling for their operating area and the prices for natural gas and electricity. Comparisons can be made by EA's together with designated government representative(s). They need to have the previous years' bills, above data and detailed information about the energy efficiency improvements implemented at that facility and V&M final report and the application for property tax reduction. The application shall consist of, but cannot be limited to: facility description, occupancy, previous and new building energy system description and operation, energy efficiency improvements, accomplished energy savings in percentages, present property taxes and other pertaining information. The application shall be fill by a qualified person, a PE who had previous involvement with that specific project. The people benefiting from the property tax reduction shall pay him.

The above program shall:

1. Reduce energy use, operating expenses and increase occupant comfort in existing buildings.

2. Increase the number of building owners and operators who seek, and value, information regarding improving occupant comfort while reducing the cost of building operation.

3. Increase the number of building owners and operators who institute an energy management plan for their buildings.

4. Develop education and training programs that assist building owners and operators in achieving energy efficiency and pollution prevention goals.

5. Work with building owners and operators to implement energy efficiency projects and document program services delivered to customers. Reduce energy usage and operating expenses and increase occupant comfort in existing buildings.

Small Retail and Services Sector Program

For this program, we will use a whole-building concept. A large building is divided into smaller areas to accommodate owner-operated retail or services businesses. These areas need to be kept at the desired comfort level and the Owners, Operators and/or Tenants need to reduce the operation cost associated with the building energy systems: HVAC/R, plumbing and lighting. One major way to achieve energy savings and/or increase, energy efficiency is to have in place a Preventive Maintenance Program (PM). This can be done by the Owner's own people, or contracted out to a Mechanical Contractor. If the tenants pay the utility bills, they have to get together, select a PM contractor and sign an agreement with him. This approach is cost effective compared to the one in which each tenant will have a different PM Contractor. If the utilities bills are included in the rent, the Owner shall select the PM Contractor.

If the building has a central utility system, HVAC/R and plumbing, and tenant pays for the utility bills, the tenant share of the PM contract cost shall be proportional with the area occupied by each tenant. If each of the tenants has a HVAC/R and plumbing system, the PM contractor shall provide individual tenant(s) with prices for their agreement(s) but give them a substantial discount for entire building. Most of the building energy users are part of the mechanical systems: HVAC/R, plumbing and compressed air. The equipment requiring PM can be but it, is not limited to: air compressors, boilers, chillers, rooftop AC units, cooling towers, domestic hot water heaters, pumps, blowers, air handler units, controls, etc. To provide PM to the above-mentioned equipment requires a, highly specialized, person. The PM required by lighting system, can be done with less qualified people because it involves only the cleaning, and/or replacing, of the lamps.

Part of the mechanical PM program is to have a full inventory of the equipment. Routine work includes, but it is not limited to: changing and/or cleaning of the air/water filters, coils and burners, checking the refrigerant level for AC units, combustion tests and/or water treatment for boilers and cooling towers, etc. The amount of time and/or type of work mentioned-above shall be done in accordance with the signed agreement by all interested parties: the PM Contractor and the Owner and/or Operator. The agreements (contracts) can be for one or multiple year(s), two or three, before it is bid again.

If the contract is for multiple years, the building Owner and/or Operator shall require the contracting party (supplier of the PM contract) to provide him with an Energy Audit. Only the qualified personnel shall perform the required light Energy Audit. The energy audit shall include, but shall not be limited to, type and description of: building occupancy area(s), audited (SF), energy consumption evaluation for the last 2-3 years, energy conservation measures, describing existing situation/operation and proposed improvements in operation and/or projects, calculation of the energy savings, project(s) estimation and financial justification. Also, the energy audit must include an energy management plan and a multi-year budget for energy and energy efficiency improvements and priorities. The performer, energy auditor (EA), shall have a strong experience in the energy efficiency field, HVAC/R, plumbing and lighting design, BSME/BSEE, holder of a valid PE license and/or have other recognized and approved certification.

Each multi-year PM contract shall include an energy audit. The Energy Audit shall benefit both parties: the Owner and/or Operator and PM Contractor. The Owner(s) and/or Operator(s) will benefit because it will be brought to their attention ways to save energy and money and how to lower the operation costs of, or in, their buildings.

The PM Contractor can benefit, because he, will identify the new projects and, has the most chances to implement them. Other third parties can benefit also if the energy auditor will identify non-mechanical projects: more efficient lighting, better and/more insulation for roofs and walls, energy efficient windows and/or doors, etc.

Also, the Owner and/or Operator shall require in their agreement with the PM contractor that the new equipment coming into the building for new projects and/or replacing existing ones must meet the “Energy Star” standards. Above all, the proposed and/or implemented recommendation shall be done without reducing and, if possible, improving occupant comfort level.

Before being presented to the Owner and/or Operator the energy audit report shall be reviewed and approved by the PM Contractor. When presented to the Owner and/or Operator the report shall bear the signatures of the EA and PM Contractor's authorized representative. Other benefits for the Owner and/or Operator shall be lower rates on Demand Maintenance and priority on services when equipment malfunction(s) will occur.

To prevent pollution and be environmentally compliant at all locations included in this program, the PM contractor shall hire from, through or contract out to somebody else, this side of the business. The pollution control inspector (PCI) shall be a graduate engineer, BSME/BSCE, with 2-3 years experience in environmental engineering, pollution control and environmental compliance area(s). This person shall inspect every 3 years the existing commercial building(s) assigned to him. If this person will encounter a situation requiring more expertise, the proper advice can come from the specialized personnel of SEF (specialized engineering firm). SEF shall provide advice in addition to energy efficiency and environmental engineering services (design and/or design/built) in all the area(s) mentioned above.

For larger buildings, the EA(s) can be replaced with an energy engineer/manager (EEM). The “Administrator” shall provide 23 on site EEM's to all companies who can't have their own. The amount of labor supplied by the EEM's shall be in accordance and/or agreement with the plant(s) management request(s) (8-12 hrs/week or more if needed at each location). The EEM's shall: evaluate the energy usage for the last 3 years, provide the plant with an energy audit, obtain financing and management approval for the identified projects, negotiate energy rates an tariffs, purchase energy, design an energy management plan with a multi-year budget for energy and energy efficiency improvements 25. Also, the EEM's shall set up annual goals for reducing energy consumption. If the projects are approved and money is available, the EEM shall write the design/build specifications for contractors and/or the scope of work for consulting engineers. All EEM's must solicit, evaluate and review bids from design/build contractors 48, 49, 50. See FIG. 3B. Also part of the job is to recommend to the plant management the successful bidder based on quality, ability to perform the job and price. If it is a major project and/or requires the services of a specialized engineering firm (SEF), the EEM(s) shall hire, with the plant(s) management approval, one of the contractors identified in this proposal, SEF on time and materials, not to exceed, basis. During the engineering process, the EEM shall have meetings with all parties involved and make sure that the outcome will be in accordance with his ideas and concepts. Also, the equipment specified, shall meet the “Energy Star” standards. After the design is complete, the EEM must supervise the implementation by providing field supervision, construction and project management services. All invoices submitted by contractors shall bear the signature and approval of the EEM and plant designated representative. Only after that, the contractor can receive payment for his work.

If the customer intends to expand and build a new addition to the existing facilities, the EEM shall identify all requirements from the mechanical and electrical point of view and provide the information to the plant management. If required, with the assistance of specialized personnel identified in the present proposal, the EEM can provide an approximate cost estimate for budget purpose. Above all, the EEM's shall be the company liaison with/between utilities (electric, gas and water), AE firms, specialized energy efficiency/environmental engineering firm and contractors.

The EEM must be a qualified person, fully experienced in the design of HVAC/R, compressed air, plumbing, piping, pumping and lighting/electrical systems with strong exposure to energy efficiency, holder of a valid PE license and a BSME/BSEE. In addition to that a CEM certification will be beneficial. The number of EEM's can be decided, based on demand.

To prevent pollution and be environmentally compliant at all locations included in this program, the PM contractor shall hired from, through or contract out to somebody else, this side of the business. The pollution control inspector (PCI) shall be a graduate engineer, BSME/BSCE, with 2-3 years experience in environmental engineering, pollution control and environmental compliance area(s). This person shall inspect every 3 years the existing commercial building(s) assigned to him. This inspection frequency may be increased if necessary. If this person will encounter a situation requiring more expertise, the proper advice can come from the specialized personnel of SEF. SEF shall provide advice in addition to energy efficiency and environmental engineering services (design and/or design/built) in all the area(s) mentioned above.

It shall be specially noted that the EA/EEM shall determine every year the energy consumption: natural gas, oil and electricity, per square foot, of each building assigned to him/her. Changes in energy consumption shall be quantified in percentages. The changes in percentages for thermal energy and electricity consumption per square foot can be combined to come out with the average. This percentage, hopefully, will go down due to the energy efficiency improvements. As an incentive to promote energy efficiency, the STATE and/or the local government having jurisdiction shall reduce the property taxes accordingly. Every year the local power and/or the natural gas distribution company shall record the amount of degree heating/cooling for their operating area and the prices for natural gas and electricity. Comparisons can be made by EA's together with designated government representative(s). They need to have the previous years' bills, above data and detailed information about the energy efficiency improvements implemented at that facility and V&M final report and the application for property tax reduction. The application shall consist of, but cannot be limited to: facility description, occupancy, previous and new building energy system description and operation, energy efficiency improvements, accomplished energy savings in percentages, present property taxes and other pertaining information. The application shall be fill by a qualified person, a PE who had previous involvement with that specific project. The people benefiting from the property tax reduction shall pay him.

To reinforce all of the above, the State shall require from all contractors selling PM contracts to provide an energy and environmental audit, disclose every year how many energy and environmental audits were perform by them, or on their behalf, and provide the proof, the report(s). If desired by the PM contractor(s), the EA(s), EEM(s) and PCI(s) can be provided by the Administrator. The cost must be supported by the State. A light energy audit shall not take more than 40 hours and the environmental one not more than 24 hours.

The above program shall:

1. Reduce energy use, operating expenses and increase occupant comfort in existing buildings.

2. Increase the number of building owners and operators who seek and value information regarding improving occupant comfort while reducing the cost of building operation.

3. Increase the number of building owners and operators who institute an energy management plan for their buildings.

4. Developed education and training programs that assist building owners and operators in achieving energy efficiency and pollution prevention goals.

5. Work with building owners and operators to implement energy efficiency projects and document program services delivered customers. Reduce energy use, operating expenses and increase occupant comfort in existing buildings.

Industrial: Energy Intensive Industries Sector Program

Only the holder of this “Patent,” through designated contractors, previously authorized, shall do all related technology transfers.

This entire business model requires the cooperation of universities, government entities, private companies, media, profit and non-profit organizations, energy users of all kinds and sizes, and, above all, a reliable source of money.

Industrial: General Industry Sector Program

This program shall apply to a wide range of industries (all SIC codes). Also subject to this program are Production Agriculture and Water and Wastewater sectors.

The “Administrator” shall provide on site energy engineers/managers (EEM's) to all companies who cannot have their own. The amount of labor supplied by the EEM's shall be in accordance and/or agreement with the plant(s) management request(s) (8-12 hours/week or more if needed at each location). The EEM's shall: evaluate the energy usage for the last 3 years, provide the plant with an energy audit, obtain financing and management approval for the identified projects, negotiate energy rates and tariffs, purchase energy, design an energy management plan with a multi-year budget for energy and energy efficiency improvements. Also, the EEM's shall set up annual goals for reducing energy consumption. If the projects are approved and money is available, the EEM shall write the design/build specifications for contractors and/or the scope of work for consulting engineers. All EEM's must solicit, evaluate and review bids from design/build contractors. Also, part of the job is to recommend to the plant management, the successful bidder based on quality, ability to perform the job and price. If it is a major project and/or requires the services of a specialized engineering firm (SEF), the EEM(s) shall hire, with the plant(s) management approval, one of the contractors identified in this proposal, SEF, on a time and materials, not to exceed, basis. During the engineering process, the EEM shall have meetings with all parties involved and make sure that the outcome will be in accordance with his ideas and concepts. Also, the equipment specified shall meet the “Energy Star” standards. After the design is complete, the EEM must supervise the implementation by providing field supervision, construction and project management services. All invoices submitted by contractors shall bear the signature and approval of the EEM and plant designated representative. Only after that, the contractor can receive payment for his work.

If the customer intends to expand and build new addition to the existing facilities, the EEM shall identify all requirements from the mechanical and electrical point of view and provide the information to the plant management. If required, with the assistance of specialized personnel identified in the present proposal, the EEM can provide an approximate cost estimate for budget purpose. Above all, the EEM's shall be the company liaison with/between utilities (electric, gas and water), AE firms, specialized energy efficiency/environmental engineering firm and contractors.

The EEM must be a qualified person, fully experienced in the design of HVAC/R, compressed air, plumbing, piping, pumping and lighting/electrical systems with strong exposure to energy efficiency, holder of a valid PE license and a BSME/BSEE. In addition to that, a CEM certification will be beneficial. The number of EEM's can be decided based on demand.

To prevent pollution and be environmentally compliant at all locations included in this program, the EEM shall have by his side a pollution control inspector (PCI). The PM contractor shall be hired from, through or contract out to somebody else, this side of the business. The PCI shall be a graduate engineer, BSME/BSCE, with 2-3 years experience in environmental engineering, pollution control and environmental compliance area(s). This person shall inspect every year the existing industrial building(s) assigned to him. If this person encounters a situation requiring more expertise, the proper advice can come from the specialized personnel of SEF (specialized engineering firm). The SEF shall provide advice in addition to energy efficiency and environmental engineering services (design and/or design/built) in all the area(s) mentioned above.

It should be specially noted that the EEM shall determine, every year, the energy intensity factors. For thermal energy, the factor shall be in btu/1000 lb of product shipped and for electricity shall be in KWH/1000 lb of product shipped. These factors shall be compared with ones from the previous year. The comparison shall reveal a percentage of increase or decrease of the energy intensity. Changes in energy consumption shall be quantified in percentages. The changes in percentages for thermal energy and electricity consumption per square foot can be combined to come out with the average. This percentage, hopefully, will go down due to the energy efficiency improvements. As an incentive to promote energy efficiency, the STATE and/or the local government having jurisdiction shall reduce the property taxes accordingly. Every year the local power and/or the natural gas distribution company shall record the amount of degree heating/cooling for their operating area and the prices for natural gas and electricity. Comparisons can be made by EA's together with designated government representative(s). They need to have the previous years' bills, above data and detailed information about the energy efficiency improvements implemented at that facility and V&M final report and the application for property tax reduction. The application shall consist of, but cannot be limited to: facility description, occupancy, previous and new building energy system description and operation, energy efficiency improvements, accomplished energy savings in percentages, present property taxes and other pertaining information. The application shall be fill by a qualified person, a PE who had previous involvement with that specific project. The people benefiting from the property tax reduction shall pay him.

To reinforce all of the above, the State shall require from all contractors selling PM contracts, to provide an energy and environmental audit, disclose every year how many energy and environmental audits were perform by them, or on their behalf, and provide the proof, the report(s) 27, 28, 29, 30, 31, 33, 34, 35, 36, 37. See FIG. 3A. If desired by the PM contractor(s), the EA(s), EEM(s) and PCI(s) can be provided by the Administrator 23. The cost must be supported by the State. A light energy audit shall not take more than 40 hours and the environmental one no more than 24 hours.

The above program shall:

1. Reduce the energy intensity of all industrial customers in the state.

2. Increase the number of industries that develop and implement an energy management plan.

3. Provide comprehensive training and educational programs to help industries achieve their energy efficiency and pollution prevention goals.

4. Worked with participants to implement energy efficiency projects and document program services delivered to customers.

Agricultural Markets-Production Agriculture Sector Program

This program can be a program by itself and shall be implemented and/or managed by electric cooperatives. See FIG. 6. They have their own qualified personnel able to provide and advise their main customers. The farms, commodity suppliers and distributors must be provided with a light energy audit 151, 152, 153, 154. The environmental audit shall be much cheaper to prevent future problems in the food chain.

The energy efficiency part of this program is very simple. The audit shall be done by a licensed engineer with 2-4 years experience in the energy efficiency area and an additional 2-4 years in the design and operation of the mechanical/electrical systems and shall be signed together with the electric cooperative designated representative 154. Another PE, employed by The Administrator of Major Markets shall review and sign the entire audit 155. After “The Audit” is signed by a wide group of interested parties, the end customer shall apply for funds to the “Fund” 10. The cooperatives know their customer best and better than anybody else. They shall provide all the necessary and required guarantees. The State of Wisconsin shall also provide its own guarantees to cover the cooperatives and/or their customers. The owner shall be asked if he wants to go further or not 156, 157, 158, 159. If he desires to go ahead 159, the electric cooperative employee in charge of this project shall negotiate his company mark up 160. Once this issue has been decided the project can go ahead. Based on the audit recommendation the electric cooperative designated employee shall write the design/build specifications 161 and bid them out to qualified contractors (minimum of 3). The design/build specifications shall be written by the PE and be passed on to local qualified contractors. A bid meeting shall be set. At that meeting shall be discussed all the issues and matters related to the projects and the bids. All discussion must be in front of the end customer's designated representative(s). Once the bids are received, there shall be a bid review. At the bid review meeting, it shall be discussed what contractor(s) are offering, anticipated implementation problems and, the most important, prices. The selection shall be done by the owner but with the advice of the person who performed the audit and wrote the design/build specifications. The “Fund” designated people (CE, IE, EE) and the State representative in charge of the fund shall review all available information, including the credit ones, and make their own decision. If a positive decision was made the funds necessary for the projects shall be made available except the contingency one. During the construction period, a designated representative of the electric cooperative shall provide site inspections and/or construction management services. Also, he/she shall be the liaison between the “Fund,” owner, contractors and the electric cooperative. The “Fund” 10 shall pay all the contractors' invoices associated with that project after and only if owner designated and/or qualified representatives approve them and are countersigned by the cooperative employee in charge of the project. And that is not all. A “Fund” designated employee and/or representative shall verify if the invoices paid are justified. This shall be done at random. After one year from the date when the project is closed, he/she shall call in the V&M team. The V&M team shall pass all their findings to all parties involved (see the financing mechanism program, which follows).

It shall be specially noted that the EEM shall determinate every year the energy intensity factors. For thermal energy the factor shall be in btu/1000 lb of product shipped and for electricity shall be in KWH/1000 lb of product shipped. These factors shall be compared with the ones from previous year. The comparison shall reveal a percentage of increase or decrease of the energy intensity. The EEM shall calculate the average between those two percentages (thermal and energy). This average percentage shall be compared with the one from the previous year. The comparison shall reveal a percentage of increase or decrease of the energy intensity. Changes in energy consumption shall be quantified in percentages. The changes in percentages for thermal energy and electricity consumption per square foot can be combined to come out with the average. This percentage, hopefully, will go down due to the energy efficiency improvements. As an incentive to promote energy efficiency, the STATE and/or the local government having jurisdiction shall reduce the property taxes accordingly. Every year the local power and/or the natural gas distribution company shall record the amount of degree heating/cooling for their operating area and the prices for natural gas and electricity. Comparisons can be made by EA's together with designated government representative(s). They need to have the previous years' bills, above data and detailed information about the energy efficiency improvements implemented at that facility and V&M final report and the application for property tax reduction. The application shall consist of, but cannot be limited to: facility description, occupancy, previous and new building energy system description and operation, energy efficiency improvements, accomplished energy savings in percentages, present property taxes and other pertaining information. The application shall be fill by a qualified person, a PE who had previous involvement with that specific project. The people benefiting from the property tax reduction shall pay him.

The above program shall:

1. Create partnership among existing and new agricultural service providers to improve the overall efficiency and sustainability of the production agricultural industry.

2. Work with all agricultural customers in Wisconsin to reduce the energy intensity of their operations and prevent pollution.

3. Increase the number of agricultural customers who seek and value information regarding improving the efficiency of their operations while reducing costs.

4. Develop a comprehensive education and training program to assist agricultural customers in achieving their energy efficiency and pollution prevention goals.

Schools Sector Program

This program will be based on WEI-2 and CESA. See FIG. 5. In addition to that, the people which are doing the very light energy audits for the schools can make extra money if they bring to the “FUND” real business which makes sense. In order to make the extra money, they shall bring to the “FUND” following information:

1. A much better and detailed Energy Audit showing the potential savings and signed by a PE 131, 132, 133, 134, 135, 136, 137, 139.

2. Three quotations 138 from three different qualified design/build contractors, and an explanation to the “FUND” designated representative as to all the reasons why one of them was selected. Also, they shall provide 140 the design/build specifications associated the projects listed in the energy audit and bid on by the contractors.

3. A signed “Letter of Interest” from the school decision maker(s) 141 stating their immediate interest in the project(s) listed in the energy audit and bid(s) from qualified contractors.

All this information shall be given proper consideration by the “Fund” decision makers 142.

If the funds are approved 143 and issued in accordance with “Financing Mechanism,” the party who brought to the “Fund” 10 the above mentioned information will be advised by the “Fund” representative 22 to enter into direct negotiations with the school 144, 145, 146, 147, 148. They can negotiate a percentage of the total cost of the project for providing site inspections, construction and project management. One year after the closing of the project, they shall call in the V&M team and coordinate the whole thing. If the project is sold, and only after that, the party who brought the project to the “Fund” 10 shall receive from the “Fund” a bonus valued at 2% of the total cost of the project. The bonus shall be called “The Finder's Fee” 149. The “Fund” 10 would like the “Finder's Fee” receiver to mention to the school decision makers about CPI and what he/she will do for them. The Finder's Fee is basically a commission, percentage of the entire order value obtained with the assistance of a third party who did not have or need any license and/or prior long or short term agreements to represent the seller(s). The Finder's Fee is a success fee and shall be paid only if the supplier of the product/services or the seller(s) of the business or part of it did receive the payment from the buyer(s) found by the third party. This fee shall be paid on domestic and/or international deals regardless of the third party, buyer(s) or seller(s) location. The Finder's Fee shall be valid in the investment cases when a third party found and identified the investment and recommended it to a qualified and/or interested investor. In this case the investor shall pay the fee, which fee can be in cash or a share in that business. Also the business owners who sold part of their business shall pay the fee to the third party, who identified the buyer(s), in shares of that business deducted from their remaining shares.

Where it is possible and if not in conflict with CESA people, an EEM can be assigned to each school district. If the “Fund” 10 will received a call from a private school and/or a technical college, it shall try first to divert this kind of prospective customers to CESA people. If no one is interested and/or do not have the required qualifications to bring projects to the “Fund” 10, the “Fund” 10 shall start all the necessary investigations on its own.

The above program shall:

1. Greatly increase the interest in energy efficiency at the public school districts, private schools and technical colleges.

Government Buildings Sector Program

One major way to achieve energy savings and/or increase energy efficiency is to have in place a Preventive Maintenance Program (PM). This can be done by the Owner's own people, or be contracted out to a Mechanical Contractor. Why a mechanical contractor? Most of the building energy users are part of the mechanical systems: HVAC/R, plumbing and compressed air. The equipment requiring PM can be, but it is not limited to: air compressors, boilers, chillers, rooftop AC units, cooling towers, domestic hot water heaters, pumps, blowers, air handler units, controls, etc. To provide PM to the above-mentioned equipment requires a highly specialized person.

The PM required by lighting system can be done with less qualified people, because it involves only the cleaning and/or replacing of the lamps. Part of the mechanical PM program is to have a full inventory of the equipment. Routine work includes, but it is not limited to: changing and/or cleaning of the air/water filters, coils and burners, checking the refrigerant level for AC units, combustion tests and/or water treatment for, boilers and cooling towers, etc. The amount of time and/or type of work mentioned-above shall be done in accordance with the signed agreement by all interested parties: the PM Contractor and the Owner and/or Operator. The agreements (contracts) can be for one or multiple year(s), two or three, before it is bid again. If the contract is for multiple years, the building Owner and/or Operator shall require the contracting party (supplier of the PM contract) to provide him with an Energy Audit. Only the qualified personal shall perform the required light Energy Audit. The energy audit shall include, but shall not be limited to, type and description of: building occupancy, area(s) audited (SF), energy consumption evaluation for the last 2-3 years, energy conservation measures, describing existing, situation/operation and proposed improvements in operation and/or projects, calculation of the energy savings, project(s) estimation and financial justification. Also, the energy audit must include an energy management plan and a multi-year budget, for energy and energy efficiency improvements and priorities. The performer, energy auditor (EA), shall have a strong experience in the energy efficiency field, HVAC/R, plumbing and lighting design, BSME/BSEE, holder of a valid PE license and/or have other recognized and approved certification. Each multiyear PM contract shall include an energy audit. The Energy Audit shall benefit both parties: the Owner and/or Operator and PM Contractor.

The Owner(s) and/or Operator(s) will benefit because it will be brought to their attention ways to save energy and money and how to lower the operation costs of, or in, their buildings. The PM Contractor can benefit because he will identify the new projects and has the most chances to implement them. Other third parties can benefit, also, if the energy auditor will identify non-mechanical projects: more efficient lighting, better and/more insulation for roofs and walls, energy efficient windows and/or doors, etc.

Also the Owner and/or Operator shall require in their agreement with the PM contractor that the new equipment coming in to the building, for new projects and/or replacing existing ones, must meet the “Energy Star” standards. Above all, proposed and/or implemented recommendation(s) shall be done without reducing and if possible improving the occupant(s) comfort level. Before being presented to Owner(s) and/or Operator(s), the energy audit report shall be review and approved by the PM Contractor. When handed to the Owner and/or Operator, the report shall bear the signatures of the EA and PM Contractor, authorized personnel. Other benefits for the Owner and/or Operator shall be lower rates on Demand Maintenance and priority on services when equipment malfunction(s) will occur.

To prevent pollution and be environmentally compliant at all locations included in this program, the PM contractor shall hire from, through or contract out to somebody else, this side of the business. The pollution control inspector (PCI) shall be a graduate engineer, BSME/BSCE, with 2-3 years experience in environmental engineering, pollution control and environmental compliance area(s). This person shall inspect every, 3 years the existing, government building(s) assigned to him. If this person will encounter a situation requiring more expertise, the proper advice can come from the specialized personnel of SEF (specialized engineering firm). SEF shall provide advice in addition to energy efficiency and environmental engineering services (design and/or design/built) in all the area(s) mentioned above.

In some special cases when a large Government building is involved, the Energy Auditor can be replaced with an “on site” energy engineer/manager (EEM). In this case, the amount of labor supplied by the EEM's shall be in accordance and/or in agreement with the amount of labor required by the building Operator (8-12 hr/week or more if needed).

The EEM's shall: evaluate the energy usage for the last 3 years, provide the plant with an energy audit, obtain financing and management approval for the identified projects, negotiate energy rates and tariffs, purchase energy, design an energy management plan with a multi-year budget for energy and energy efficiency improvements. Also, the EEM's shall set up annual goals for reducing energy consumption. If the projects are approved and money is available, the EEM shall write the design/build specifications for contractors, and/or the scope of work, for consulting engineers. All EEM's must solicit, evaluate and review bids from design/build contractors. Also part of the job is to recommend to the plant management the successful bidder based on quality, ability to perform the job, and price. If it is a major project, and/or required, the services of a specialized engineering firm (SEF) shall be hired, with the plant(s) management approval, one of the contractors, identified in this proposal, SEF, on a time and materials, not to exceed, basis. During the engineering process, the EEM shall have meetings with all parties involved and make sure that the outcome will be in accordance with his ideas and concepts. Also, the equipment specified shall meet the “Energy Star” standards. After the design is complete, the EEM must supervise the implementation by providing field supervision, construction and project management services. All invoices submitted by contractors shall bear the signature and approval of the EEM and plant designated representative. Only after that, the contractor can receive payment for his work.

If the customer intends to expand and build a new addition to the existing facilities, the EEM shall identify all requirements from the mechanical and electrical point of view and provide the information to the plant management. If required, with the assistance of specialized personnel identified in the present proposal, the EEM can provide an approximate cost estimate for budget purpose. Above all, the EEM's shall be the company liaison with/between utilities (electric, gas and water), AE firms, specialized energy efficiency/environmental engineering firm and contractors.

The EEM must be a qualified person, fully experienced in the design of HVAC/R, compressed air, plumbing, piping, pumping and lighting/electrical systems with strong exposure to energy efficiency, holder of a valid PE license and a BSME/BSEE. In addition to that, a CEM certification will be beneficial. The number of EEM's can be decided, based on demand.

To reinforce all of the above, the State shall require from all contractors selling PM contracts, to provide an energy and environmental audit, disclose every year how many energy and environmental audits were performed by them, or on their behalf, and provide the proof, the report(s). If desired by the PM contractor(s), the EA(s), EEM(s) and PCI(s) can be provided by the Administrator 21. The cost must be supported by the State. A light energy audit shall not take more than 40 hours and the environmental one not more than 24 hours.

The above program shall:

1. Reduce the energy intensity, operating expenses and increase occupant comfort in existing buildings.

2. Increase the number of buildings operators who seeks and value information regarding improving occupant comfort while reducing the costs of building operation.

3. Increase the number of building operators who institute an energy management plan for their buildings.

4. Develop a comprehensive education and training program to assist building operators in achieving their energy efficiency and pollution prevention goals.

5. Work with building operators to implement energy efficiency projects and document program services delivered to customers.

Water and Wastewater Treatment Plants Sector Program

All water and wastewater plants in the state shall be privatized. The water and wastewater plants covering the same area shall be merged. The cost of water will go up and the people will start saving the water (water conservation). This shall lead to “Water Management.”The plants shall be profitable and they shall invest in themselves to cut the operation and labor costs. All EA's, EES's, EEM's and PCI's in addition to their main assignment shall look vigorously for ways to save and/or reduce the water consumption in all facilities, which are or will be part of the “Major Markets” (industrial, medical, commercial, institutional, schools, government, etc).

Energy Efficiency Related Goods and Services Program

The above-proposed programs will stimulate the demand for energy efficiency products and services. To satisfy the continuous increase in demand for energy efficiency goods and services in Wisconsin, the Wisconsin legislation shall introduce a regulation prohibiting exclusivities in the state for energy efficiency products and/or technologies. This means that more than one seller can sell a specific energy efficient product and/or a technology able to improve energy efficiency.

Assume that an EEM or EA did identify a project able to reduce the energy consumption and increase the energy efficiency. He also identified, as part of the project, a certain product made by a specific company. The product is ideally suited and a key component of the project. Presently, only one vendor has the rights to sell that product in the State of Wisconsin, the “Rep.” If he has the exclusivity for that product, he will quote to contractors a much higher price due to his substantial increase in mark up. He will profit greatly at the expense of the consumer. If his price is too high, the contractors can offer to their customers a substitute product for a lower price. The substitute product will have a lower price at the expense of the quality and/or the energy efficiency performance. When the “exclusivities” will be prohibited, more qualified vendors will contact the manufacturer of that specific product. If more vendors will try to sell the same product in the same market, the price shall fall due to the competition between them. When prices fall, the market share goes up. That means that more energy efficient products and services will be offered to the consumer. The sellers of the energy efficient goods and services shall benefit also due a substantial increase in demand. The small engineering company can benefit also. They can do all the required design, using the best and most energy efficient equipment and hire the lowest cost, but qualified, contractor to install. The price shall be much lower, using a single source for all the services than the present situation where, in many cases, one party does the design, another sells the equipment and the third party does the installation.

Another regulation, which if introduced by Wisconsin legislation will have a major effect in increasing the market share of energy efficient services, is to require licensed Mechanical Contractors doing work in Major Markets to report every year the number of environmental and energy audits done by them or on their behalf. The proof shall be the Energy and the Environmental Audit report, signed by all parties including the beneficiary. Another way to increase the sales and the market share for energy efficient goods and services is to allow them to be tax exempt. Wisconsin legislation shall vote a new law, allowing the property taxes to be reduced in the same proportion (%) with the decrease in the energy intensity factors.

The above program shall:

1. Increase market share of energy efficient technologies and services

2. Increase the number of sellers or producers of energy efficient related goods and services

3. Spur the use of technology to improve the quality, delivery or reduce prices of energy efficiency goods or services.

4. Influence the expectations of the producers and/or sellers of energy efficiency goods and services

5. Increase the availability and distribution of energy efficiency goods and services

6. Identify and address regulation that inhibit the supply or increase the price of energy efficiency goods and services.

Financing Mechanism

The State of Wisconsin shall provide a large amount of money to facilitate the creation of the “Energy, Energy Efficiency, Water Management, Environmental Protection and Pollution Prevention Fund” (“The Fund” or “Fund” 10). See FIGS. 1 and 2. All EA's, EEM's, EES 's, PCI's shall be paid 14 by the Administrator 21 from the “Fund” 10 or other sources (government and/or private) 2, 3, 4, 5, 6. The Administrator 21 shall invoice 32 the Fund 10 or other sources 2, 3, 4, 5, 6 for all their labor periodically and shall provide the proof of their labor. See also FIGS. 3A, 3B, 3C and 3D. For EA's, the proof shall be the energy audit. For EEM's, a letter signed by a designated customer representative stating the number of hours worked in a certain period of time at his location. And for the EES's, the document showing the officially agreed energy savings and a letter signed by a designated state representative 22 stating the amount of hours worked in a previously agreed period of time. The payment shall be made to the Administrator after presenting all of the above-mentioned documentation and with the approval of the State representative 22 in charge of the Fund 10.

If a project is identified 41 and the customer, interested in project implementation 42, 43, 44, 45, the person responsible for project(s) identification shall fill out an application 61 and request the necessary money from the Fund. The application 61, requesting money from the Fund 56, 57, 58, 59, shall consist of the energy audit, the design/build specifications associated with the identified project(s) or the scope of work for the SEF, the bids received from the design/build contractors or an engineering estimation, for construction budget only, provided by the SEF 46, 47. Above all, the package shall include a credit application 62, 63, 64, 65, 66, 67, 68, 69 completed by designated and specialized customer representatives. In the total amount of money requested for implementation of the project(s) shall be included the funds associated with services provided by the responsible EEM or EA during the construction process: site inspection(s), construction and project management 23. Also, a contingency of 10% shall be included.

Special attention shall be given to the energy savings and improvements identified by the EES's. The customer may have enough money to satisfy the construction based on the initial design, but it is his desire that the work required to achieve energy savings identified by the EES is to be financed by the Fund 10. In this case, the funds associated with site inspection(s), construction and project management shall be omitted. The contingency shall stay.

Three specialized people 24 shall evaluate the entire package. The specialists, engineering, credit and investment evaluators, shall have strong experience in their field of expertise. The investment evaluator (IE), shall have strong combined experience in engineering and finance. His/her education shall consist of a BSME/BSEE together with an/a MBA and PE license. The IE shall be able to talk with the beneficiary of the project(s) and find out how they select their investments and what number is acceptable to them (ROI, Payback, IRR). The engineering evaluator (EE), shall have a MSME/MSEE combined with a valid PE license. He/she shall have some exposure to finance. The credit evaluator (CE), shall have a BSBA, be experienced in this area, with some exposure to energy efficiency business.

After the evaluation is complete and all evaluators are in total agreement, a letter of agreement shall be signed 70 by all parties involved. The letter shall have a short description of the project(s), including a cost/benefits analysis 51 (NPV and ROI) and the credit limit of the customer 56. If the implementation of the project(s) exceeds the customer's credit limit, a decision 52, 53, 54, 55 shall be made regarding how to proceed. One way is to recommend approval of the funds up to the credit limit selecting the most profitable energy conservation measure(s) and/or project(s). Another way is to spread the initial investment over a longer period of time (years). The letter shall be sent to the State of Wisconsin representative 71 in charge of the Fund. The issuance of the funds is contingent upon his approval 72, 73, 74. Before the issuance of the funds, the FS shall negotiate 75 and sign 76 a “Lease” agreement with payments based on a percentage of savings (shared savings where X % of the savings shall be the payment and Y % shall remain with the project beneficiary and X+Y=100% of energy savings) 77. At the end of the lease, the beneficiary shall own the entire installation (project). The lease shall not exceed 120 months.

Once the funds are approved 77, the project(s) shall start 78, 79, 80, 81, 82. After the funds are approved, the V&M team shall start investigating and measuring the energy used by existing system(s) who will be affected by the energy improvements. After its completion and after one year of full operation, a team of qualified engineers shall verify and measure (V&M) the energy savings 91. All the accomplished savings shall be documented in a letter 92. All parties involved in the V&M process, including the team leader, shall sign the letter. Engineers with 5-10 years' experience, shall form the V&M team. The team leader shall have a minimum of 15 years experience in V&M. In addition to the above-mentioned engineers, including their team leader, shall posses a BSME/BSME and a very good understanding of building mechanical and electrical systems and strong exposure to energy efficiency technique. The time spent by the V&M team shall be documented and charged to the project 93. The time spent by the EE and IE shall be not more than 4 hours per project. The IE shall be allowed an additional 4 hours after all verification and measurement is complete. The cost of the V&M team shall be time and materials, with a not to exceed.

The letter documenting the accomplished savings shall be passed on to the investment evaluator 94. He or she shall revaluate 95 the investment based on the new and final data (measured energy savings and the final cost of the project). He shall decide 96 for how much the project(s) can be sold as investment to financial institution(s) and/or any other interested parties. The price(s) recommended by him/her shall be between a minimum and a maximum 97. Maximum price shall be based on the NPV of the future cash income provided by the X % of the accomplished (documented by V&M team) energy savings for 10 years. Minimum shall be based on the actual project cost plus a percentage. Armed with all the necessary documentation, including the State of Wisconsin guarantees, the fund salesperson (FS) shall start calling on financial institutions and/or any other interested parties. The “Papers” to be shown to the prospective “Investment” buyers shall include all the official letters, reports, customer credit application, and evaluator's recommendation and the annual income derived from energy savings part belonging to the “Fund” 10. The FS shall negotiate 98 and sell 99 the investment for a higher price than the minimum set by the investment evaluator. The FS shall be a qualified person with strong experience in selling financial instruments and/or investments. Also, he/she shall posses an MBA and a very good understanding of finance. The FS shall be a liaison between the project(s) beneficiary and the selected party interested in purchasing the investment. The FS shall facilitate the writing of the contract between the above-mentioned parties. The contract between them shall stipulate that the project(s) beneficiary shall pay to the investment buyer every year, for a previously agreed period of time, a certain amount of money. The payment schedule shall be also previously agreed upon. The contract shall also stipulate very clearly that the “Fund” will not guarantee the savings. Only the CE and the FS shall be full time employees 24 of the Fund 10. All travel and transportation expenses shall be reimbursed. If an employee or a contractor works 8 hours or more per day at one location, there shall be no charge for travel time (valid for EA's, EES's, EEM's, PCI's and V&M team). It is also optional that the CE and the FS can be one in the same.

The lease may not be sold and the “Fund” 10 shall receive all lease payments. If the projects/investments are sold at a higher price than the minimum price, the EEF can be a profitable operation. Of course, the number of projects approved and the value of the initial amount of money provided by the State can have a major impact in determining the level of profits. Also the level of advertising can have a major influence. Customers and the State shall pay the EEM's salaries. The customer share shall be between 25 and 50%. The fee charged, for advice, by the SEF shall be paid by both. The percentages shall be 50/50 but also can be a different percentage as negotiated from case to case by the fund representative and the customer, the liaison being the EEM.

In time, if the EEF will show profits year after year, and the initial amount of the money provided by the State will increase without additional influx of cash from the State or anybody else. Then the State can start to take its money back with interest at the prevailing rates. This way, the EEF will be a self-sustained, profitable business operation. It should be specially noted here that, before any work of any kind by anyone is started, the prospective customer credit must be checked. This is mandatory. Also, all accounting type work shall be done by an in-house bookkeeper/accountant. It is optional that all billings and/or invoices shall be checled and counted by an accounting firm.

The description of the operation below is valid only when and if the “Fund” will become a profitable business. This is the Stage Two.

All advertising costs, shall be back charged to the “Fund” 10 and added to the project(s) as part of their fixed cost. Other parts of the fixed costs consist of total compensation of all people, cost of rent and/utilities and the cost of transportation for the people involved. Exception shall be made for the investment evaluator (IE) and the engineering evaluator (EE). Their compensation, together with the V&M team, shall be part of the variable costs and shall be charged and/or back charged to each project. The time spent by the EE and IE shall be not more than 4 hours per project. The IE shall be allowed an additional 4 hours after all verification and measurement is completed. The cost for the V&M team services shall be time and materials, with a not to exceed.

The break-even point shall occur when sales value will become equal to the sum of fixed and variable costs. The break-even period shall be as long as is needed to absorb, little by little, all of the costs involved. At one point, IE, EE and the entire V&M team shall become full time employees of the Fund.

At this point(s), the State representative 22 in charge of the Fund 10 shall be replaced with a company president. The company president shall be a lawyer with an MBA. The company shall reorganize: the FS shall become VP of Marketing and Sales and the EE shall become Technical Director with responsibilities for quality and human resources. He/she must be responsible for the hiring of all engineers. The IE shall become Production Director. The final product, number of them, and the final cost shall be his/her responsibility. The CE shall become VP of Finance. She or he shall continue to be responsible for the credit evaluation of all prospective customers. In addition to that, he/she shall acquire an MBA and be responsible for all company finances. One of the main responsibilities is to obtain money from lending institutions at a profitable rate. That shall be done through negotiations. The president shall manage the company and have a good understanding of the business. In addition to that, he/she shall be able to solve some minor legal issues.

The company president shall franchise, sell and /or expand this type of business and/or the modus operandi to all 50 states and to any foreign country or any province(s) part of it for:

1. LICENSE LEASE. For a percentage of the total amount of money received by “The Fund” for projects/investments sold to interested parties. The license shall be for a specified period of time, as previously agreed. For a negotiable percentage of moneys paid by the State for energy savings identified by the EES's. For a negotiable percentage of the profit realized from the labor of EA's, EES's, EEM's, PCI's and any other employee involved in “The Project.” Also a negotiable percentage of the total annual project costs paid by the “Fund.”

2. OUTRIGHT SALE of the concept for a lump sum (negotiable but based on market size) and/or an asset exchange.

3. TECHNOLOGY TRANSFERS via JOINT VENTURES between the Wisconsin “Fund” and interested parties located in the respective areas (all issues are negotiable).

4. CONTRACT out to some locals to do the work only (salaries to be paid shall be similar or little better than the ones paid for similar work in that specific area). Local management shall receive a negotiable percentage of the accrued profits.

5. If the patent is leased for an agreed upon period of time, to a local or national government, that government can distribute the money for salaries to local qualified mechanical and/or electrical contractors and engineering companies to hire/perform the work assigned to EES, EEM, EA and PCI. In this case, the benefiting parties (engineering companies, mechanical and electrical contractors, environmental consulting firms, etc.) shall pay a fee. The fee shall be negotiated and shall be a percentage of the money to be received by the parties in that period of time. The recipients of the funds shall be qualified and meet a few criteria: long and successful business history and a design/build department with at least 1-2 PE's.

This business model can be licensed, sold or contracted to more than one organization in/for a designated area.

Training and Education Programs Curriculum

At all ABET accredited universities located in Wisconsin, the university decision makers shall introduce classes at undergraduate and/or graduate level in HVAC/R, illumination, plumbing, compressed air, controls and energy conservation strategies and above all about energy efficiency. Students will learn about: system sizing, equipment selection, basic design methods, type of equipment used, equipment sizing and selection, piping, pumping, building electrical/mechanical system(s) including power supply/distribution for mechanical equipment and many other things needed to design. In addition to that, the students shall be required to design themselves all the above systems for a small building: school, strip mall, library, industrial facility, or offices. During their training at the ABET accredited universities, all students interested in architectural engineering shall be asked to complete at least four projects for four different types of buildings using CAD/CAE. During the summer between their third and fourth years and only after they have passed the examinations and test(s) for some of the classes mentioned above as part of the interdisciplinary curriculum, the students shall be employed, full time, for 3 months by local AE firms. During their fourth year in college, the students shall be required to design four projects and take the Engineering Economics class. They shall have some experience from the knowledge they acquired.

They must provide drawings, calculations, explain the design solution and, specifications. Above all, they shall present the economical analyses and/or justification on which they based their entire design.

The Curriculum describe below consists of, but is not limited to, the following classes (courses):

Program Lease:

All ABET accredited Universities and Colleges can use this program for a previously agreed period of time and if they will pay negotiable percentage of tuition.

The Third Year:

Mechanics of Fluids course (4 hours/week, spring semester continued from second year). The course shall consist of, but is not limited to, the study of pumping and applications of pumps and fans.

Electro Techniques course (4 hours/week, spring semester continued from second year). The course consists of, but is not limited to: electrical motors, transformers, and generators, AC and DC, and their applications.

Thermo Techniques course (4 hours/week, spring semester continued from second year). This course consists of, but is not limited to: Thermodynamics and heat transfer. Steam, Thermodynamic laws and cycles, internal combustion engines, steam diagram(s), conduction, convection and radiation heat transfer, etc.

Engineering Economics course (3 hr/week, fall semester). This course consists of, but is not limited to: Life cycle analysis, NPV, Pay Back, ROI, IRR, BUY/MAKE, LEASE Calculation, etc.

Thermo Machines and Devices course (6 hours/week, spring semester). This course consists of, but is not limited to: Learn about fuels, combustion equations, burners, boilers and heat exchangers.

General Construction course (4+ hours/week, spring semester). This course consists of, but is not limitated to Design criteria for steel and concrete structure, foundations vibrations. Loads, energy efficient doors, windows and insulation.

Plumbing Systems Course (4 Hours/Week, Spring Semester).

This course consists of, but not limited to, Concepts and design criteria for plumbing, hot and cold water, sewage, compressed air, oxygen, natural gas, and loads calculation, specifications. Also shall be discussed industrial plumbing and related environmental problems.

Practical Work (Project Design Under Supervision of an Associate Professor, Specialized, PE)

General Structural Project (4 Hours/Week, Spring Semester).

Design of a steel or concrete structure with multiple floors and concrete foundations. Use most energy efficient construction materials (Green Buildings)

Thermal Machines and Devices Project (4 Hours/Week, Spring Semester).

Design a, hot water boiler and heat exchanger.

Plumbing Project (4 Hours/Week, Fall Semester).

Concepts and design criteria for plumbing, hot and cold water, sewage, compressed air, oxygen, natural gas and fuel systems. Learn about system sizing, equipment selection, and loads calculation, specifications. Building type: commercial, office, light industrial, institutional or educational.

Work Experience (summer and fall semester) 12-hr/week, doing plumbing work for an AE firm. Complete design package including but not limitated to: calculations, sizing, equipment selection, drawings, estimation, and specifications.

Gain practical experience in plumbing design concepts and systems: hot and cold water, sewage, compressed air, oxygen, natural gas and fuel systems. Perform system sizing, equipment selection, calculation, and specifications.

Foreign Languages Seminar (3 hours/week, whole year). (French, Spanish, Russian or German) This course consists but is not limitated to: Learn technical language and conversation with emphasis in construction.

Standard HVAC Systems Course (4 Hours/Week, Fall Semester)

This course consists, but not limited to,: Comfort and design criteria, heat gain/loss calculation, psychometrics, description of different HVAC equipment, equipment and/or equipment components. Conceptual design and selection of the proper design solution(s). Description of a wide range of HVAC systems: steam, hot water, forced air, VAV, etc.

Refrigeration Systems Course (4 Hours/Week, Fall Semester)

This course consists but is not limitated to: Learn about design criteria and applications of ammonia, absorption machines, freons, refrigeration cycle, condensers, compressors, and evaporators. Study refrigeration applications for: refrigeration furniture for food store, refrigerated warehouse, ammonia plants and walk in coolers. Conceptual design and selection of the proper design solution(s). Also learn to calculate loads and how to size and select components, parts or the entire refrigeration systems

The Fourth Year

Electrical Systems Course (4 Hours/Week, Spring Semester)

This course consists of, but not limited to, Concepts and design criteria for illuminating, power distribution systems, equipment and system sizing, equipment selection, type of lamps and fixture. Learn to select the proper application and the most economical one. Apply all knowledge gained in Engineering Economics.

Foreign Languages Seminar (3 hours/week, whole year). (French, Spanish, Russian or German) This course consists but is not limitated to: Learn technical language and conversation with emphasis in construction.

Standard HVAC System Course (Part 2) (4 Hours/Week Spring Semester)

This course consists, but not limited to,: Learn about system sizing, equipment selection, and most important how to put a system together. Specifications. Building type: commercial, office, light industrial, institutional or educational.

Practical Work (Project Design Under Supervision of an Associate Professor, Specialized, PE)

Refrigeration Project (4 Hours/Week, Spring Semester) Design refrigeration system for a wide range of applications. Refrigeration for Food stores, warehouses, walk in coolers or small ammonia for a food processing plant.

HVAC Project (4 Hours/Week, Spring Semester)

Gain practical experience in HVAC design systems: calculations, evaluation of alternatives, alternative selection, Learn how to size systems and equipment, economical calculations based on fuel, cost and maintenance. Complete design package including but not limitated to: calculations, sizing, equipment selection, drawings, and estimation specifications.

Electrical Project (4 Hours/Week)

Design lighting, power distribution and alarms systems for buildings. Gain practical experience in HVAC design systems: calculations, evaluation of alternatives, alternative selection. Complete design package including but not limitated to: calculations, sizing, equipment selection, drawings, specifications and estimations. Special emphasis shall be given to application of day lighting in buildings.

Work Experience (summer and fall semester) 20 hr/week doing HVAC, electrical and refrigeration work. Complete design package including but not limitated to: calculations, sizing, equipment selection, drawings, and estimation and specifications. Economical analysis and solution justification selected projects. Work under the supervision of a Senior Engineer or a Project Manager.

The Fifth Year

Work Experience (spring and summer) 20 hr/week doing HVAC, electrical and refrigeration work. Complete design package including but not limitated to: calculations, sizing, equipment selection, drawings, and estimation and specifications. Economical analysis and solution justification selected projects. Work under the supervision of a Senior Engineer or a Project Manager.

Controls and Energy Management Course (3 Hr/Week, Spring Semester)

This course consists of, but not limited to, Learn about control strategies for a wide range of lighting, plumbing, compressed air, refrigeration and HVAC systems. DDS, Building Automation Systems and their components must be part of this class.

Learn how to make the annual energy budget for a building, and a 5 year energy conservation plan.

Facilities Engineering, Construction and Project Management Course. (3 Hr/Week, Fall Semester)

This course consists, but not limited to: Learn about facilities management and operations departments operates, subcontracting, PM Contracts, construction management, bids issue and bids review, construction budgets, field changes, maintenance and maintenance budget and project management techniques /methods.

Visits to facilities departments, mechanical and/or electrical contractors to find out how they work.

Energy Efficiency Course (3 Hr/Week, Spring Semester)

This course consists, but not limited to,: Learn methods to save energy: Heat recovery, economizers, relamping, demand control for electricity and compressed air, peak sheaving, VAV, use of VFD, insulation, energy efficient windows and doors. These subjects shall be studied in the class but not only them. Provide schematics, sample calculations, estimations and economical justification.

Specialty HVAC Course (3 Hr/Week, Fall Semester)

This course consists, but not limited to,: Learn about HVAC required by special application: dust collection systems, garages ventilation and exhaust systems, IAQ, draying systems, vacuum systems, clean rooms, surgery rooms, computer rooms, telecommunications centers etc.

Work Experience (Fall semester) 20 hr/week designing plumbing, controls, HVAC, electrical (lighting and power supply), refrigeration for a wide range of projects. Complete design package including but not limitated to: calculations, sizing, equipment selection, drawings, and estimation and specifications. Economical analysis and solution justification for selected building or energy conservation projects. Work under the supervision of a Senior Engineer or a Project Manager. Also, the student shall perform 1 or 2 energy audits and a certain number of site inspections

Foreign Languages Seminar (3 hours/week, whole year). (French, Spanish, Russian or German) This course consists but is not limitated to: Learn technical language and conversation with emphasis in construction.

The Sixth Year

Small and Medium Size, Cogeneration, Waste to Energy Power Plants, Renewable Energy Sources, Heating and Cooling District(s), Course. (4 Hr/Week, Spring Semester)

This course, consists of, but is not limited to: cogeneration and its application for hospitals, district heating and cooling, industrial parks, large commercial developments, universities etc. Study the economics and how the municipal waste can be use as fuel and obtain electricity, hot water and chilled water for district heating/cooling. Application of solar and wind energy. (Paper work instead of exam)

IAQ and Environmental Compliance, Course (2 Hr/Week, Spring Semester)

Learn about ventilation standards, indoor air quality, testing of the air, methods to improved it, EPA and State regulation in case of an unfortunate accident, spillage or pollution and light remediation and recommendations.

Diploma Project

The student shall work for an AE firm, 30 hours/week, evaluating, selecting/justifying the selected alternative, contacting customers, developing relations with equipment suppliers, designing all building energy systems, and providing an energy budget to customers. The best situation will be if the selected building needs all mechanical and electrical systems studied by the student in the previous years (HVAC, plumbing, lighting, power supply, controls, alarms, refrigeration). If refrigeration is not required in that specific building, an additional project shall be done consisting only of refrigeration. Complete design package including, but not limited to: calculations, sizing, equipment selection, drawings, estimation and specifications. Economical analysis and solution justification for selected systems. Work under the supervision of a Senior Engineer or a Project Manager. The presentation shall be in front of specialized professors, his supervisors from the AE firm and/or the design/build contractor specialized in refrigeration. It should be noted that this program is adjustable and can be made shorter or longer and can be use by students to obtain a BS/MS. Credits shall be given for documented work experience and/or a PE license even if the experience or the license was acquired prior to student admission to the “Facilities Construction, Management and Engineering” Program. Also credits can be given for courses taken at other ABET or ABET equivalent programs. Each ABET accredited program shall have its own evaluation or shall base the decision on written documents issued by other ABET accredited program. The program can be BS or MS. Inform the Public About the Importance of Energy Efficiency.

All utilities in the State shall be required to send the “Flyer” to all their customers included in the Major Market sector.

All distributors shall provide training and promote energy efficiency to their customers, the contractors. It is in their interest.

Marketing Program

The Major Market Administrator shall retain all responsibility for marketing efforts related to its programs.

Advertising

Advertising shall be first only on television, statewide and at all local stations.

The “Commercial” shall be three minutes long and the message must be brief, direct and striking. This is necessary to attract the attention of a wide range of interested parties and have them contact us for details by phone. The “Commercial” spot shall be in prime time when the local news is presented and only once a day every day of the week.

1. To be successful, the commercial shall show a young, pretty and very sexy women, dressed sexy (short paints or tight blue jeans). Ideally, she should have a slight accent.

She shall say the fallowing reading from a script:

“I am new on the US market, and I am learning how to sell myself and my product in the world's most competitive market. My product is my “Fund.” I like the Wisconsin market because it is a good one for my product. My “Fund” is the product that I would like to sell. My “Fund” is a nice one and is for all of you interested in energy conservation and to save money. Wisconsin “Fund” is big and will save your energy. You do not have to run a lot to find the money for your energy efficiency projects. I do not know what all of this means, but all I know is that “The Fund” is full of money.

If you like and understood what I told you about me and my “Fund” which, by the way, is funded by the State of Wisconsin, please call me and my “Fund” at 1-800-MY-CHEAP and ask the experts about me or the “Wisconsin Fund.” You will be very pleased, I guarantee you. The “Wisconsin Fund” does not offer any, but I do.

PS. I forgot to tell you that my “Fund” and me, we both are very cheap. We are the cheapest on the market, because we both want to be successful, and I know for sure that there is a lot of competition out there that speaks a lot and better but does much less. They asked me to read this script because I am a new one, with no experience in this area of expertise. I never sold any “Fund.” I have to sell my “Fund” first. After that, I will welcome invitations from managers of other funds to sell theirs. My “Fund” and me will kiss you now. Bye, and I hope to hear from you soon.” Signature “Name of The Girl”

Paid for by The State of Wisconsin

Every thing said by her shall be written at the bottom of the screen just in case that some people (viewers) will not understand her perfectly.

The “Fund” shall receive a lot of calls. Some will be become leads, some will not. To decide which one is a lead, a few questions must be asked by the people answering the calls.

The first question is mandatory and if the answer is “No,” there shall be no more questions.

The “Question” is: “Are you interested in “The Girl” or in her “Fund”?” If their interest is for “The Girl” all pertaining data shall be taken: agent and/or model agency name, address, phone number, contact person, etc. If he is interested in “The Fund,” the next question shall be:

1. Do you own, work, represent or know a company interested in saving energy? If the answer is “Yes,” the next question is about his/her identity.

His/her name. “His” shall be his real name, backed up by his title and the length of his employment with “Her.” “Her” name means the name of his company. Also needed is their address and telephone number. Once we have all that, we can send them a flyer. The “Flyer” shall be very simple explaining the “Fund” business in layman's terms.

The following things shall be very clearly explained:

1. That there are money to be used only for energy conservation/energy efficiency project(s) and it is provided on a temporary basis by the State of Wisconsin. The State of Wisconsin will facilitate lending of all the necessary money for the above-mentioned type projects.

2. What kind of company is the company who asked for the flyer? The interested party shall explain this in detail. If it is a consulting and/or a contractor, they shall be directed to the nearest State office where new construction projects are approved and the permit are issued. There they shall meet the EES. He/she shall be able to explain the whole thing to them. If the company is a manufacturing, real estate, educational institution, medical or government facility, it shall be directed to the FS.

The next question to be asked by both FS and EES at the meeting is if the company has its own qualified people taking care of energy/energy efficiency problem. If the answer is “Yes,” have them contact the FS directly. The FS shall be able to explain them all about. If the answer is “No,” many more questions shall be asked in order to sell them the EEM's, EA's PCI's and all the rest. After the above meeting(s) take place, this lead may become a qualified lead. This shall happen if, but not only, the prospective customer needs one of the “Fund” services. The FS and/or EES's shall make the proper recommendation based on their knowledge and understanding of the business. The prospective customer shall leave the meeting with a brochure. Also after the phone conversation, the FS shall send them one.

The “Brochure” shall be sent to all specialized distributors (HVAC/R, plumbing, electrical/lighting and controls). They shall pass the “Brochure” on to contractors. Also, through them, the contractors can and shall require the services of the EA's. One EA shall be assigned to a few distributors located in the same area. The assignment must be selected, very carefully, without creating “Conflicts of Interest” of any kind and/or affecting anybody's interest. All parties involved shall sign a “Memorandum of Understanding” stipulating their responsibilities and limitations. That shall be done, from case to case, based on distributor capabilities (its design abilities, site inspection, etc). The distributors can have a major role in this business model. Specialized people shall develop “The Brochure.”

Present Product Line and Development

The “Fund” product it is what he has to sell. The “Fund” 10 must sell many products, all of them necessary to support the product that will make a lot of money for the “Fund” energy efficiency projects. Above all, the “Fund” 10 shall sell to Wisconsin the idea that a lot of people can make money of the energy efficiency, energy, water management, environmental protection and pollution control. Other intermediary products (components) must be: the Energy and Environmental Audit, EA's, EES's, EEM's, PM Contracts, and PCI's. EA's, EEM's, EES's and PCI's shall be able to recommend, make demonstrations and sell to customers different products that can increase the efficiency and energy efficiency. They shall also train the buyers on how the products shall be used. These products can be, but are not limited to: Preventive Maintenance, Engineering, Project Estimation, and Investment and Financial Analysis Software. They can sell these products only if the manufacturer/producer of these products does not have a representative in that area that has the exclusivity to sell them. For selling those products the administrator shall receive a Finder's Fee from the manufacturers. The administrator shall compensate the EA's, EEM'S, EES's and PCI's with a percentage of the Finder's Fee received from the manufacturer. Manufacturer and the prospective buyers shall negotiate the prices. If the sale takes place, the manufacturer shall invoice the buyer directly and assume all the liabilities for his product. The administrator shall not be held liable for product defects, delays in shipment, product loss or nonpayment by the buyer. This is a present product line, which is acceptable to the market, and a lot of people can make money out of them.

New products, in development, shall be Environmental, Pollution Control and Prevention Projects. But this is in the future. Nobody makes money from them now. All EES's, PCI's and EEM's shall push LEED. LEED has 5 environmental goals:

1. Planning sustainable sites

2. Improving energy efficiency

3. Conserving materials and resources

4. Enhancing indoor environmental/air quality (IAQ)

5. Safeguarding water

Distribution Channels

The projects shall come to the “Fund” 10 through four major channels:

1. Identified, sent by and through all the Electric Cooperatives in the State.

2. Identified for, and sent to, the “Fund” 10 by all the EEM's and EES's located statewide.

3. Identified by the EA's, for the “Fund” 10 and PM Contractors statewide and send in with their and their customer approval. Sometimes, with distributor help.

4. Identified and brought to the “Fund” 10 by CESA people with the approval of the school decision makers.

The projects shall leave the “Fund” 10 and be sold to many interested parties. These prospective customers including, but not limited to: banks, pension funds, insurance companies, and private domestic and foreign investors, investment brokers who can sell them to their customers, etc.

Pricing, Pricing Strategy and Competition

Recommended mark up by the “Fund” 10 on the projects shall be 10%. However the IE shall made the final recommendation based on all inputs (shortage or excess of customers, beneficiary investment requirements, market condition, competition, etc).

At the beginning, there shall be a penetration strategy (one year) to get acceptance from the market. The mark-up can be 10-15%. After one year, starting from the date of the first Sale, to anyone interested, the pricing strategy shall be reviewed.

The competition will come from ESCO'S and the ESCO-type companies.

The ESCO's provide a turnkey project. They will do it all: energy audit, financing arrangement with third party financing, total engineering, purchasing of major equipment and V&M, construction and project management. Sometimes they provide maintenance, also on a contract basis. Above all, they fully guarantee the entire amount of energy savings.

The ESCO-type companies enter into this kind of business only to be able to sell their product: building automation systems and HVAC/lighting equipment. The following businesses operate this way: Johnson Controls, Honeywell, Siemens, Carrier, GE and Trane. Some of them will provide third party financing but only if they can sell their product. Most of the engineering and construction is subcontracted (design/build) and some have their own V&M team(s). They provide already full guarantees for energy savings and labor, in some cases. All can offer PM contracts on customer request.

The budget for marketing shall be discussed and agreed by all parties interested and/or involved and must have funds for marketing startup (phone lines and people to answer the phone calls. Also, for the place where this activity shall take place. Printing budget shall be a minimum $250,000 for the first year. This number can be adjusted in any direction.

Market Assessment Program

To evaluate and assess the market we need to know:

1. The value of all the projects proposed by a wide range of parties to the “Fund” 10.

2. The total value of the projects approved by “The Fund” 10.

3. The “Fund” sales.

All these numbers shall be readily available. In addition to that, the State of Wisconsin shall have its own consultant, Market Transformation and Assessment Consultant (MTAC).

Renewable Energy Program

This program shall promote solar heating, day lighting, wind power and “Waste to Energy” power plants.

To be cost effective, the solar heating (building heating and heating of domestic hot water) and day lighting shall be included in the original design by the AE or added later to the same but modified design by the EES. These additions can be easily funded by the “Fund” with the Owner agreement. The products associated with solar heating and day lighting, shall be tax exempt and after they are in place the Owner shall benefit from additional tax relief on his/her property taxes. The tax relief shall be of 2% continuous, but only one time. The one time 2% relief shall occur in the year when the installation was completed and stay at the same level if nothing else will happen.

The Wind Power can be also achieved but has limited opportunities. Much more opportunities are in the area of Waste to Energy. From domestic and/or municipal waste through clean incineration can be obtained steam and electricity. The domestic/municipal waste shall be the fuel of the future. From steam can be obtain hot water for “District Heating” in winter, and chilled water for “District Cooling” during summer time. Electricity and domestic hot water shall be available all the time. Special applications include: large apartment complexes, industrial parks, military bases and university and hospital campuses.

Final Note

The word “Wisconsin” can be replaced with the name of any state, part of the state or USA, any province(s) or part of any foreign country or just with the name of a foreign country. All data pertaining to the level of experience, education and licensure/registration can be adjusted to accommodate a wide range of needs. All percentages are adjustable and can be changed up or down. To increase competition, this business model can be franchised to more than one organization within a designated area. Any US or foreign organization part of the government and/or private can provide the guarantees.

Alternate Solution(s)

The money, required for marketing and, to employ all the necessary people can be furnished by government(s) entities.

The funds necessary to implement the projects can be made available by private sources. For projects involving energy, energy efficiency, environment protection, pollution prevention and/or water management any agreement(s) between parties involved can replace “The Lease” agreement.

The entire amount of money required to implement this “Business Model” could be supplied by private sources 5, 6. The guarantees can be provided by any state, country, and financial institution private, public or government(s) owned.

Parts of the entire amount of money required to implement this “Business Model” could be supply by private sources 5, 6, and the other parts, by government entities 3, 4 or vice versa.

The entire amount of money required to implement this “Business Model” could be supply by government entities through private sources or by private sources through government entities.

The Fund 10 may be owned by a third party that can be a governmental and/or private entity.

The Fund 10 can keep the investment projects and receive direct lease payments from project beneficiaries.

From the foregoing, it will be apparent that there has been provided a new and useful method for developing and promoting certain operations and services under a specialized collection of programs that are financially supported by a fund that is established for energy efficiency, water management, environmental protection and pollution purposes.

The principles of this invention having been fully explained in connection with the foregoing, I hereby claim as my invention:

1. A method for developing and promoting operations and services in the areas of energy, energy efficiency, water management, environmental protection and pollution prevention which comprises the steps of
establishing an energy, energy efficiency, water management, environmental protection and pollution prevention find, said fund being available to finance all or part of the implementation of certain projects for customers, which projects incorporate energy, energy efficiency, water management, environmental protection and pollution prevention measures,
appointing engineering, credit and investment specialists, said specialists being the evaluators of projects which incorporate energy, energy efficiency, water management, environmental protection and pollution prevention measures,
selecting the most profitable energy conservation measures for each such project,
recommending approval of certain financing for each such project, and
approving financing for each such project.

2. The method of claim 1, including, after said financing approving step, the steps of
starting each such project,
completing each such project,
verifying and measuring the savings of each such project after one year of full operation of the project,
preparing a letter documenting accomplished energy savings of each such project, and
reevaluating the energy savings and the final cost of each such project.

3. The method of claim 2 wherein said fund establishing step includes the step of establishing a fund under the governmental territory of any state, part of a state, part of the United States, any province or any part of foreign country or the foreign country itself.

4. The method of claim 3 wherein said fund establishing step includes the step of providing sources of moneys for the fund through local or national utilities, domestic and international government institutions, private and government owned financial institutions, domestic or international private third parties and/or third party governments.

5. The method of claim 2, the steps of providing an energy efficiency specialist to evaluate new building projects with a view toward saving energy in excess of code requirements, documenting the energy savings of each such project, having the fund pay an amount to a major markets administrator as an incentive, and generating a source of revenue.

6. The method of claim 2, including the step of providing a preventive maintenance program for equipment in existing buildings and further including, after said project completing step, the steps of engaging an energy auditor to perform an energy audit of the building equipment and engaging a pollution control inspector to prevent pollution.

7. The method of claim 6, including the step of engaging an energy engineer/manager to supervise the implementation of energy efficiency improvements in existing buildings by providing field supervision, construction and project management services.

8. The method of claim 7, including the steps of determining the energy intensity factors on an annual basis, reducing property taxes as an incentive for implementing energy conservation measures, and increasing profits.

9. The method of claim 2 including the step of engaging an energy engineer/manager for evaluating energy usage and setting goals for reducing energy consumption and the step of engaging a pollution control inspector to prevent pollution and to ensure environmental compliance in existing buildings.

10. The method of claim 9, including the steps of comparing energy consumption every year with the prior year and reducing property taxes as an incentive to promoting energy efficiency.

11. The method of claim 2, including the step of engaging a preventive maintenance contractor to reduce operation costs associated with building energy systems in all types of buildings, requiring the preventive maintenance contractor to conduct an energy audit, engaging a pollution control inspector to prevent pollution and to ensure environmental compliance and reducing property taxes as an incentive to promote energy efficiency.

12. The method of claim 2, including the step of working with existing and new agricultural service providers to improve overall efficiency and sustainability of the production agricultural industry, to reduce the energy intensity of their operations and to prevent pollution.

13. The method of claim 2, including the steps of negotiating with schools for energy conservation measures to be incorporated by them in their new school design drawings, increasing the interest in energy efficiency in such schools and providing an incentive in the form of a “finder's fee” to a party who brings the school project to the fund.

14. The method of claim 2, including the step of privatizing all water and wastewater plants for the purpose of saving and/or reducing the water consumption and to provide a source of revenue for the organizations doing privatization.

15. The method of claim 5, including the step of paying energy efficiency specialist from the fund.

16. The method of claim 6, including the steps of paying the energy auditor from the fund.

17. The method of claim 7, including the steps of paying the energy engineer/manager from the fund.

18. The method of claim 11, including the steps of paying the pollution control inspector from the fund.

19. The method of claim 1, including the steps of offering energy conservation curriculums to accredited universities at the undergraduate and/or graduate levels, requiring such curriculums to include courses in HVAC/R, illumination, plumbing, compressed air, controls, energy conservation strategies and energy efficiency, and requiring such universities to pay a percentage of tuition for use of this curriculum.

20. The method of claim 1, including the step of prohibiting exclusiveness for energy efficiency products and/or technologies.

21. The method of claim 2, including the step of having the salaries of certain employees paid by both private clients and government.

22. The method of claim 2, including the step of paying a fund administrator, to his subcontractor or to any third party a finder's fee from the manufacturers.

23. The method of claim 2, including the steps of having the fund give money to private companies for the purpose of employing certain specialized personnel and providing a source of revenue.

24. The method of claim 2, including the step of selling a lease contract to interested parties as an investment.

25. The method of claim 24, including the step of having the government guarantee lease payments.

26. The method of claim 2, including the step of having the state require preventive maintenance contractors to provide an energy audit and an environmental audit on a periodic basis.

27. The method of claim 2, including the steps of having a design/build organization that is not a product manufacturer purchasing equipment for a specific design/build project directly from the manufacturer and providing a source of additional revenues for that organization.

28. The method of claim 2, including the steps of having a third party organization promote competing products, having the third party receive a finder's fee if such products are purchased by a customer directly from the manufacturer/producer, and providing a source of revenue for the administrator or his subcontractor.

29. The method of claim 2, including the steps of requiring the customer who is the beneficiary of the reduction in the property tax to pay for the services of a qualified engineer employed to file an application and providing additional revenue for the administrator of the fund or his subcontractor(s).
